(19) United States
(12) Patent Application Publication
(10) Pub. No.: US 2026/0052222 A1
(43) Pub. Date: Feb. 19, 2026

(54) IMAGE RECORDING APPARATUS AND IMAGE RECORDING METHOD

(71) Applicant: CANON KABUSHIKI KAISHA, Tokyo (JP)

(72) Inventors: HITOSHI MIZUTANI, Tokyo (JP); HIROSHIGE TSUGAWA, Kanagawa (JP)

(21) Appl. No.: 19/369,946

(22) Filed: Oct. 27, 2025

Related U.S. Application Data
(63) Continuation of application No. PCT/JP2024/017310, filed on May 9, 2024.

(30) Foreign Application Priority Data
May 12, 2023 (JP) 2023-079583
May 12, 2023 (JP) 2023-079586

(51) Int. Cl. H04N 5/77; H04N 5/91

(52) U.S. Cl. CPC H04N 5/77; H04N 5/91

(57) ABSTRACT

An image recording apparatus that has a pre-recording function for, prior to start of instructed recording, starting recording of an image captured using an image sensor is disclosed. The image recording apparatus performs the pre-recording and starts the instructed recording of the image captured using the image sensor according to a determination that an instructed-recording starting condition is satisfied while the pre-recording is performed. The image recording apparatus performs the pre-recording onto a non-volatile recording medium that is used for the instructed recording.

### CROSS-REFERENCE TO RELATED APPLICATIONS

This application is a Continuation of International Patent Application No. PCT/JP2024/017310, filed May 9, 2024, which claims the benefit of Japanese Patent Application Nos. 2023-079583 and 2023-079586, filed May 12, 2023, all of which are hereby incorporated by reference herein in their entirety.

### BACKGROUND

### Field of the Technology

The present disclosure relates to an image recording apparatus and an image recording method.

### Description of the Related Art

In an image recording apparatus such as a digital camera, there is known a function (pre-recording function) for starting recording in advance without waiting for a recording instruction from a user and thereby preventing a failure in intended image recording that would otherwise be caused by a delayed recording instruction (Japanese Patent Laid-Open No. 2001-257976).

The longer the period (hereinafter “pre-recording period”) during which an image is recorded by the pre-recording function is, the more convenient it becomes for the user. However, it would be necessary to hold data corresponding to the pre-recording period to realize a long pre-recording period. If data corresponding to the pre-recording period is held in an internal memory (RAM), for example, the duration of the pre-recording period would be constrained by the capacity available in the internal memory.

### SUMMARY

Some embodiments according to the present disclosure provide an image recording apparatus and an image recording method that make it possible to relax the constraint relating to the duration of the pre-recording period.

According to an aspect of the present disclosure, there is provided an image recording apparatus that has a pre-recording function for, prior to start of instructed recording, starting recording of an image captured using an image sensor, the image recording apparatus including one or more processors that execute a program stored in a memory and thereby function as units comprising: a pre-recording processing unit configured to perform the pre-recording; and an instructed-recording processing unit configured to start the instructed recording of the image captured using the image sensor according to a determination that an instructed-recording starting condition is satisfied while the pre-recording is performed, wherein the pre-recording processing unit performs the pre-recording onto a non-volatile recording medium that is used for the instructed recording.

According to another aspect of the present disclosure, there is provided an image recording method to be executed by an image recording apparatus that has a pre-recording function for, prior to start of instructed recording, starting recording of an image captured using an image sensor, the image recording method comprising: performing the pre-recording; and starting the instructed recording of the image captured using the image sensor according to a determination that an instructed-recording starting condition is satisfied while the pre-recording is performed, wherein the pre-recording is performed onto a non-volatile recording medium that is used for the instructed recording.

According to a further aspect of the present disclosure, there is provided a non-transitory computer-readable medium that stores a program for causing a computer of an image recording apparatus that has a pre-recording function for, prior to start of instructed recording, starting recording of an image captured using an image sensor, to execute an image recording method comprising: performing the pre-recording; and starting the instructed recording of the image captured using the image sensor according to a determination that an instructed-recording starting condition is satisfied while the pre-recording is performed, wherein the pre-recording is performed onto a non-volatile recording medium that is used for the instructed recording.

According to another aspect of the present disclosure, there is provided an image recording apparatus that has a pre-recording function for, prior to start of instructed recording, starting recording of an image captured using an image sensor, the image recording apparatus including one or more processors that execute a program stored in a memory and thereby function as units comprising: a determination unit configured to determine a method for the pre-recording; a pre-recording processing unit configured to, according to the method determined by the determination unit, start the pre-recording of the image captured using the image sensor; and an instructed-recording processing unit configured to start the instructed recording of the image captured using the image sensor according to a determination that an instructed-recording starting condition is satisfied while the pre-recording is performed, wherein, while the pre-recoding is performed, in a case where the method determined by the determination unit is changed, the pre-recording processing unit performs the pre-recording according to the method after the change.

According to a further aspect of the present disclosure, there is provided an image recording method to be executed by an image recording apparatus that has a pre-recording function for, prior to start of instructed recording, starting recording of an image captured using an image sensor, the image recording method comprising: determining a method for the pre-recording; according to the determined method, starting the pre-recording of the image captured using the image sensor; starting the instructed recording of the image captured using the image sensor according to a determination that an instructed-recording starting condition is satisfied while the pre-recording is performed; and while the pre-recording is performed, in a case where the method determined by the determining is changed, performing the pre-recording according to the method after the change.

According to another aspect of the present disclosure, there is provided a non-transitory computer-readable medium that stores a program for causing a computer of an image recording apparatus that has a pre-recording function for, prior to start of instructed recording, starting recording of an image captured using an image sensor, the image recording method comprising: determining a method for the pre-recording; according to the determined method, starting the pre-recording of the image captured using the image sensor; starting the instructed recording of the image captured using the image sensor according to a determination that an instructed-recording starting condition is satisfied while the pre-recording is performed; and while the pre-recording is performed, in a case where the method determined by the determining is changed, performing the pre-recording according to the method after the change.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram for describing a recording control operation according to a first embodiment.

FIG. 2 is a block diagram illustrating an example of a functional configuration of a digital camera according to the first embodiment.

FIG. 3 is a flowchart relating to the recording control operation according to the first embodiment.

FIG. 4 is a diagram for describing a recording control operation according to a second embodiment.

FIG. 5A is a flowchart relating to the recording control operation according to the second embodiment.

FIG. 5B is a flowchart relating to the recording control operation according to the second embodiment.

FIG. 6 is a block diagram illustrating an example of a functional configuration of a digital camera according to a third embodiment.

FIG. 7 is a diagram for describing a pre-recording control operation according to a third embodiment.

FIG. 8 is a diagram for describing an instructed-recording control operation according to the third embodiment.

FIG. 9 is a diagram for describing the instructed-recording control operation according to the third embodiment.

FIG. 10A is a flowchart relating to a recording control operation according to the third embodiment.

FIG. 10B is a flowchart relating to the recording control operation according to the third embodiment.

FIG. 11 is a diagram for describing the instructed-recording control operation according to the third embodiment.

FIG. 12A is a flowchart relating to a recording control operation according to a fourth embodiment.

FIG. 12B is a flowchart relating to the recording control operation according to the fourth embodiment.

FIG. 13A is a flowchart relating to a recording control operation according to a fifth embodiment.

FIG. 13B is a flowchart relating to the recording control operation according to the fifth embodiment.

FIG. 14A is a flowchart relating to a recording control operation according to a sixth embodiment.

FIG. 14B is a flowchart relating to the recording control operation according to the sixth embodiment.

### DESCRIPTION OF THE EMBODIMENTS

In the following, embodiments will be described in detail with reference to the attached drawings. Note that the following embodiments are not intended to limit the scope of the claims. While multiple features are described in the embodiments, it is not the case that all such features are essential; furthermore, multiple features may be combined as appropriate. Furthermore, in the attached drawings, the same reference numerals are provided to configurations that are the same or similar, and redundant description thereof is omitted.

Note that, in the following, a case will be described in which embodiments according to the present disclosure are implemented on a digital camera. However, the embodiments according to the present disclosure can be implemented on any appropriate electronic device having an image-capturing function. Such electronic devices include video cameras, computer devices (personal computers, tablet computers, media players, PDAs, etc.), mobile telephones, smartphones, gaming devices, robots, drones, and drive recorders. These are examples, and the embodiments according to the present disclosure can also be implemented on other electronic devices.

### First Embodiment

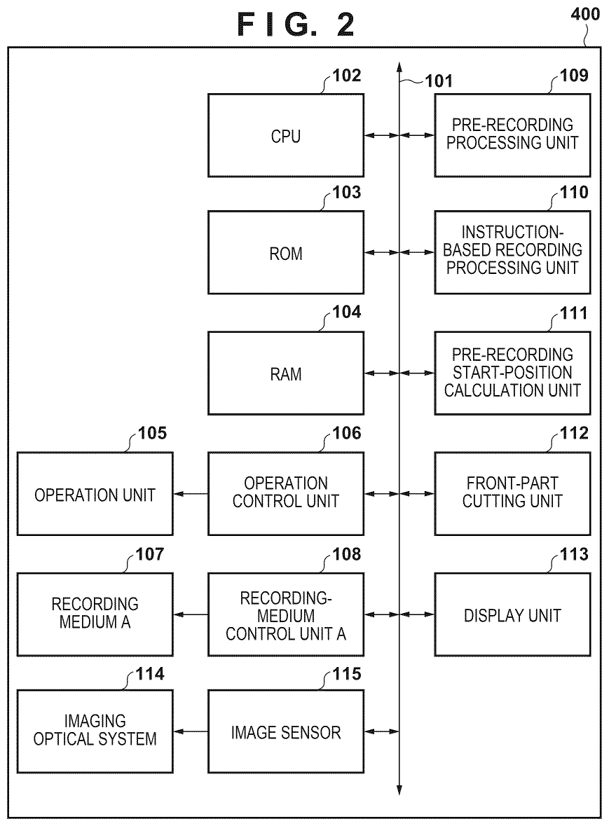

FIG. 2 is a block diagram illustrating an example of a functional configuration of a digital camera 100, which is an example of an image recording apparatus according to the present embodiment.

A bus 101 includes one or more address buses, data buses, and control buses. The bus 101 allows functional blocks connected thereto to communicate commands and data with one another.

A CPU 102 realizes functions of the digital camera 100 by loading and executing, in a RAM 104, one or more programs stored in a ROM 103, and thereby controlling operations of functional blocks of the digital camera 100.

The ROM 103 is a rewritable non-volatile memory, and has stored therein one or more programs to be executed by the CPU 102, various setting values of the digital camera 100, GUI data, etc.

The RAM 104 is a volatile memory, and is used to temporarily store one or more programs executed by the CPU 102, and information necessary for program execution, such as variables. Furthermore, the RAM 104 is also used as a memory for buffering image data, a video memory for a display unit 113, etc.

An operation unit 105 collectively refers to input devices (one or more buttons, switches, dials, etc.) that are provided in order to allow a user to input various instructions to the digital camera 100. The input devices constituting the operation unit 105 have names corresponding to the functions assigned thereto. For example, the operation unit 105 includes a release switch, an image-shooting-mode select dial for selecting the image-shooting mode, a menu button, direction keys, a confirmation key, etc. Furthermore, the input devices may be software buttons or keys making use of a touchpanel display. Furthermore, the operation unit 105 may include an input device supporting a contactless input method, such as voice input or eye-gaze input.

An operation control unit 106 detects that the user has operated the operation unit 105, and provides the CPU 102 with a notification of the detected operation.

In the present embodiment, the digital camera 100 has a still-image mode and a moving-image mode, and switching between modes is possible using the operation unit 105. In the still-image mode, the CPU 102 recognizes a half-press state and a full-press state of the release switch as an image-shooting preparation instruction and an image-shooting start instruction, respectively. Furthermore, in the moving-image mode, the CPU 102 recognizes an operation of the release switch during an image-shooting standby state as a moving-image recording start instruction. Furthermore, the CPU 102 recognizes, as a moving-image recording stop instruction, an operation of the release switch that is performed during recording of a moving image from a state in which no operation of the release switch is detected. Note that, in the moving-image shooting mode, the CPU 102 regards both the half-press state and the full-press state of the release switch as an operation of the release switch, and makes no distinction therebetween.

Note that the operation unit 105 may include a moving-image recording switch separately from the release switch. In this case, the digital camera 100 records a still image or a moving image in accordance with the switch operated in the image-shooting standby state. Specifically, the CPU 102 recognizes the half-press state and the full-press state of the release switch as a still-image-shooting preparation instruction and a still-image-shooting start instruction, respectively. Furthermore, the CPU 102 recognizes an operation of the moving-image recording switch during the image-shooting standby state and an operation of the moving-image recording switch during recording of a moving image as a moving-image recording start instruction and a moving-image recording stop instruction, respectively.

For example, a recording medium 107 is a detachable and non-volatile recording medium, such as a memory card. The recording medium 107 is typically used for instructed recording, and not used for pre-recording. Note that the term “instructed recording” refers to a recording process performed in response to a recording start instruction by a user. However, in the present embodiment, still-image and moving-image data generated by the digital camera 100 is recorded to the recording medium 107 during both pre-recording and instructed recording. Note that the recording medium 107 may be an external non-volatile recording medium (e.g., an HDD, an SSD, or the like) that the digital camera 100 can access.

Note that, in the present description, the phrases “data to be recorded” and “recorded data” are respectively used to refer to data used for recording (i.e., data prior to recording) and data recorded in a recording medium or the like (i.e., data subsequent to recording).

A recording-medium control unit 108 controls the reading and writing of data from and to the recording medium 107. Specifically, upon receiving a read command from a requester, the recording-medium control unit 108 reads the read-target data recorded in the recording medium 107 a predetermined size at a time, and stores the read data in the RAM 104. Furthermore, upon receiving a write command from a requester, the recording-medium control unit 108 writes the write-target data stored in the RAM 104 a predetermined size at a time to the recording medium 107.

Furthermore, upon receiving a remove command from a requester, the recording-medium control unit 108 removes data recorded in the recording medium 107. Data may be removed by writing data corresponding to a specific value, or altering management information of data as though the data has been removed. The recording-medium control unit 108 provides the requester with a notification of completion of reading or writing of data that has been performed in accordance with a command. For example, the requester may be the CPU 102, a pre-recording processing unit 109, an instructed-recording processing unit 110, or a front-part cutting unit 112.

As processing for managing a control-target recording medium, the recording-medium control unit 108 monitors the free space in the recording medium 107. In response to requests from the CPU 102, the pre-recording processing unit 109, the instructed-recording processing unit 110, etc., the recording-medium control unit 108 provides a notification of the free space in the recording medium 107. Furthermore, the recording-medium control unit 108 may be configured so as to provide the CPU 102, the pre-recording processing unit 109, the instructed-recording processing unit 110, the front-part cutting unit 112, etc., with a notification in a case in which the recording medium 107 enters a predetermined state, such as if the free space in the recording medium 107 has been exhausted.

An imaging optical system 114 forms an optical image of a subject on the imaging surface of an image sensor 115. The imaging optical system 114 includes: movable lenses such as a focus lens for adjusting the focal distance and a zoom lens for changing the angle of view; an aperture stop the aperture of which is variable; and mechanisms for driving the movable lenses and the aperture stop. The movement of the movable lenses and the aperture stop is controlled by the CPU 102.

The image sensor 115 (image-capturing unit) may be a publicly-known CCD or CMOS color image sensor that has, for example, color filters arranged in a primary color Bayer array. The image sensor 115 includes a pixel array in which a plurality of pixels are arranged two-dimensionally, and a peripheral circuit for reading out signals from the individual pixels. Each pixel accumulates a charge corresponding to the amount of incident light by a photoelectric conversion function. By reading out, from each pixel, a signal having a voltage corresponding to the charge amount generated during an exposure period, a group of pixel signals (analog image signal) representing the optical image of the subject formed on the imaging surface can be obtained. The image sensor 115 performs A/D conversion on the analog image signal to generate a digital image signal (image data), and stores the digital image signal (image data) in the RAM 104. Note that the A/D conversion may be executed by a circuit outside the image sensor 115.

The CPU 102 applies predetermined image processing to the image data stored in the RAM 104 to generate a signal or image data corresponding to the purpose of use and to acquire and/or generate various types of information. The CPU 102 stores the generated image data in the RAM 104 in accordance with the purpose of use. Furthermore, the CPU 102 controls operations of other functional blocks using the acquired information.

The image processing applied by the CPU 102 may include pre-processing, color-interpolation processing, correction processing, detection processing, data processing, evaluation-value calculation processing, special-effects processing, etc., for example.

The preprocessing may include signal amplification, reference-level adjustment, defective-pixel correction, etc.

The color-interpolation processing is performed in a case in which the image sensor is provided with color filters, and is processing for interpolating values of color components that are not included in the individual pieces of pixel data constituting the image data. The color-interpolation processing is also called demosaicing.

The correction processing may include processing such as white-balance adjustment, tone adjustment, correction (image restoration) of image degradation caused by optical aberrations of the imaging optical system 114, correction of the effects of vignetting in the imaging optical system 114, and color correction.

The detection processing may include the detection of a feature area (e.g., a face area or a human-body area) and the motion thereof, person recognition processing, etc.

The data processing may include processing such as cropping of an area (trimming), compositing, scaling, encoding and decoding, and header-information generation (data-file generation). The generation of display image data and recording image data is also included in the data processing.

The evaluation-value calculation processing may include processing such as the generation of an evaluation value and a signal to be used in automatic focus detection (AF), and the generation of an evaluation value to be used in automatic exposure control (AE).

The special-effects processing may include processing such as the addition of a blur effect, the changing of color tone, and relighting.

Note that these are examples of processing that can be applied by the CPU 102, and processing applied by the CPU 102 is not limited thereto. Note that at least part of the image processing may be applied using a hardware circuit that is different from the CPU 102. For example, the hardware circuit may an Application Specific Integrated Circuit (ASIC), a Digital Signal Processor (DSP), or a Graphics Processing Unit (GPU).

The CPU 102 adjusts the focal distance of the imaging optical system 114 by using the AF evaluation value and driving the focus lens in the imaging optical system 114. Furthermore, the CPU 102 determines exposure conditions using the AE evaluation value, and drives the aperture stop in the imaging optical system 114 in accordance with the f-number included among the exposure conditions.

The pre-recording processing unit 109, the instructed-recording processing unit 110, the pre-recording start-position calculation unit 111, and the front-part cutting unit 112 are functional blocks that execute operations relating to pre-recording and instructed recording. While these functional blocks 109 to 112 are illustrated as separate functional blocks for the sake of convenience, the functional blocks need not be implemented as individual circuits. For example, one or more of the functional blocks 109 to 112 may be realized by the CPU 102 executing a program.

Upon detecting that a pre-recording starting condition has been satisfied when pre-recording is enabled, the CPU 102 controls operations of units so that pre-recording is started. The user can set whether to enable or disable pre-recording by operating a menu screen via the operation unit 105, for example. For example, in the case of the moving-image mode, the pre-recording starting condition may be that a moving-image recording standby state (state in which a recording start instruction can be input) has been established. Furthermore, in the case of the still-image mode, the pre-recording starting condition may be that the half-press state of the release switch has been detected continuously over a predetermined amount of time without the release switch being placed in the full-press state. Note that these are examples of the pre-recording starting condition, and other conditions may be adopted.

Pre-recording is a function for starting recording in advance prior to the input of a recording start instruction from the user. Pre-recording is executed during a period from the time point when the starting condition is satisfied to the timing when a recording start instruction is input (or timing immediately preceding the start of instructed recording). Furthermore, among data that is pre-recorded (pre-recorded data), data corresponding to a predetermined period (pre-recording period) immediately preceding the input of the recording start instruction (or immediately preceding the start of instructed recording) is stored in association with data (instruction-based recorded data) recorded in response to the input of the recording start instruction.

Note that, regardless of for how long a period pre-recording has been executed, pre-recorded data having the same length is stored in association with the instruction-based recorded data. Specifically, pre-recorded data corresponding to a period going back in time by the duration of the pre-recording period from the input of the recording start instruction is stored in association with the instruction-based recorded data. The user can set the duration of the pre-recording period by operating the menu screen via the operation unit 105, for example. Pre-recording is executed at a frame rate that is in accordance with a preset setting in both the moving-image mode and the still-image mode.

Pre-recorded data and Instruction-based recorded data can be associated with one another according to any appropriate method. For example, the file names of instruction-based recorded data and pre-recorded data may be associated with one another, or the files may be associated with one another by recording file identification information e.g., the file name) of pre-recorded data in the file of instruction-based recorded data. Alternatively, the files of instruction-based recorded data and pre-recorded data may be associated with one another by recording the files in the same folder. Alternatively, in the case of the moving-image mode, pre-recorded data and instruction-based recorded data may be combined into continuous data, or pre-recorded data and instruction-based recorded data may be recorded continuously to the same data file.

Pre-recording is a function for starting recording in advance prior to the input of an instructed-recording starting instruction. Thus, the image-capturing-and-recording-related operations during pre-recording may be the same as those during instructed recording. However, in the case of the still-image mode, even if a setting to use a mechanical shutter during instructed recording is established, an image may be captured without using the mechanical shutter during pre-recording so that live view display during pre-recording is not affected.

Upon detecting that the pre-recording starting condition has been satisfied in the imaging standby state, the CPU 102 starts operations for generating data of pre-recording after modifying image-capturing-related parameters as necessary. The CPU 102 stores the generated data of pre-recording in the RAM 104. Furthermore, the CPU 102 provides the pre-recording processing unit 109 with a notification of the start of pre-recording.

Upon receiving from the CPU 102 the notification of the start of pre-recording, the pre-recording processing unit 109 transmits a write command to the recording-medium control unit 108 to start the writing, to the recording medium 107, of the data of pre-recording stored in the RAM 104. For example, the pre-recording processing unit 109 transmits the write command each time data corresponding to a write unit is stored in the RAM 104. By sequentially recording data of pre-recording stored in the RAM 104 to the recording medium 107 in such a manner, the pre-recording processing unit 109 ensures that a capacity of the RAM 104 that is used as a buffer for data of pre-recording from exceeding a predetermined capacity set in advance. Furthermore, the pre-recording processing unit 109 may provide the pre-recording start-position calculation unit 111 or the front-part cutting unit 112 with a notification of information (e.g., a frame number, a timestamp, or the like) relating to the pre-recording start position.

Upon detecting that an instructed-recording starting condition has been satisfied, the CPU 102 provides the pre-recording processing unit 109 and the instructed-recording processing unit 110 with a notification of the start of instructed recording. For example, the instructed-recording starting condition in the case of the moving-image mode may be that an operation of the release switch during pre-recording has been detected, and the instructed-recording starting condition in the case of the still-image mode may be that the full-press state of the release switch has been detected. Note that these are examples of the instructed-recording starting condition, and other conditions may be adopted.

Furthermore, upon detecting that the instructed-recording starting condition has been satisfied, the CPU 102 terminates the generation of data of pre-recording at the present frame. Furthermore, the CPU 102 starts operations for generating data of instruction-based recording after modifying image-capturing-related parameters as necessary, and stores the generated data of instruction-based recording in the RAM 104. Note that, in the moving-image mode, the operations for generating data of pre-recording may be continued and executed as operations for generating data of instruction-based recording starting from the next frame. In this case, pre-recorded moving-image data and instruction-based recorded moving-image data would have consecutive frame numbers. Furthermore, the CPU 102 provides the pre-recording processing unit 109 and the instructed-recording processing unit 110 with the notification of the start of instructed recording.

Upon receiving from the CPU 102 the notification of the start of instructed recording during pre-recording, the pre-recording processing unit 109 provides the instructed-recording processing unit 110 and the pre-recording start-position calculation unit 111 with a notification of information (e.g., identification information of the last frame of data of pre-recording) that allows the instructed-recording start position to be identified. Once the pre-recording processing unit 109 records the last frame of data of pre-recording to the recording medium 107, the pre-recording processing unit 109 stops operating.

Upon receiving from the CPU 102 the notification of the start of instructed recording, the instructed-recording processing unit 110 transmits a write command to the recording-medium control unit 108 to start the writing, to the recording medium 107, of data of instruction-based recording stored in the RAM 104. The instructed-recording processing unit 110 starts instructed recording starting from a recording start position in the recording medium 107 that is identified based on the information in the notification from the pre-recording processing unit 109. For example, similarly to the pre-recording processing unit 109, the instructed-recording processing unit 110 transmits the write command to the recording-medium control unit 108 each time data corresponding to a write unit is stored in the RAM 104. The instructed-recording processing unit 110 provides the pre-recording start-position calculation unit 111 with a notification of information (e.g., a frame number, a timestamp, or the like corresponding to when instructed recording was started) relating to the instructed-recording start position.

Upon detecting that an instructed-recording stopping condition has been satisfied, the CPU 102 controls operations of units so that instructed recording is stopped. For example, the instructed-recording stopping condition in the case of the moving-image mode may be that an operation of the release switch during instructed recording has been detected, and the instructed-recording stopping condition in the case of the still-image mode may be that the full-press state of the release switch has ceased to be detected. Note that these are examples of the instructed-recording stopping condition, and other conditions may be adopted.

Upon detecting that the instructed-recording stopping condition has been satisfied, the CPU 102 stops the generation of data of instruction-based recording at the present frame. Furthermore, the CPU 102 provides the instructed-recording processing unit 110 with a notification of the stop of instructed recording.

Upon receiving from the CPU 102 the notification of the stop of instructed recording, the instructed-recording processing unit 110 stops operating after recording data of instruction-based recording for the present frame to the recording medium 107.

Upon receiving from the instructed-recording processing unit 110 the notification of the information relating to the instructed-recording start position, the pre-recording start-position calculation unit 111 calculates information relating to the recording start position of pre-recorded data corresponding to the pre-recording period, which is to be stored in association with instruction-based recorded data. The information relating to the recording start position of pre-recorded data corresponding to the pre-recording period may be a frame number, a timestamp, or the like corresponding to the start timing of the pre-recording period. The pre-recording start-position calculation unit 111 can provide the pre-recording processing unit 109, the front-part cutting unit 112, etc., with a notification of the calculated information.

For example, the pre-recording start-position calculation unit 111 calculates a frame count corresponding to the preset pre-recording period based on the pre-recording frame rate. Furthermore, the pre-recording start-position calculation unit 111 can calculate a frame number corresponding to the recording start position of pre-recorded data corresponding to the pre-recording period by subtracting the calculated frame count from the frame number from which instructed recording was started. Alternatively, the pre-recording start-position calculation unit 111 can calculate a timestamp corresponding to the recording start position of pre-recorded data corresponding to the pre-recording period by subtracting the pre-recording duration from the timestamp corresponding to the instructed-recording start position.

The front-part cutting unit 112 removes data other than that corresponding to the pre-recording period from pre-recorded data in the recording medium 107. Specifically, the front-part cutting unit 112 transmits, to the recording-medium control unit 108, a remove command designating the range of data to be removed. The range of data to be removed is the range from the head of pre-recorded data to a point immediately preceding the recording start position of data corresponding to the pre-recording period, which is provided in the notification from the pre-recording start-position calculation unit 111.

Note that, instead of removing pre-recorded data from the head, pre-recorded data may be removed starting from the pre-recording start position based on the information provided in the notification from the pre-recording processing unit 109. Furthermore, the range of pre-recorded data to be removed from the recording medium 107 may be identified according to a method that is different from those described herein. For example, the pre-recording processing unit 109 manages the cumulative data size up to each frame from the start of pre-recording, and the front-part cutting unit 112 makes an inquiry for the cumulative data size up to the frame immediately preceding a frame corresponding to the recording start position of the pre-recording period. The front-part cutting unit 112 transmits, to the recording-medium control unit 108, a command to remove data corresponding to the cumulative data size obtained from the pre-recording processing unit 109 from the head of data.

Note that the removal of pre-recorded data by the front-part cutting unit 112 can be performed when instructed recording is started or stopped. The removal of data when instructed recording is started can increase the capacity of the recording medium 107 that can be used for instructed recording. Furthermore, the removal of data when instructed recording is stopped can prevent a conflict between access to the recording medium 107 for instructed recording and access to the recording medium 107 for data removal.

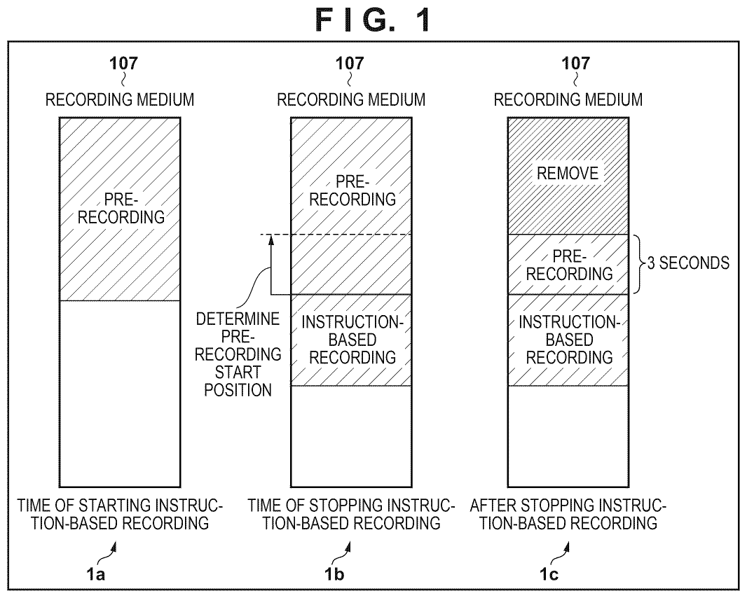

FIG. 1 is a diagram schematically illustrating the change over time of pre-recorded data and instruction-based recorded data in the recording medium 107 when the recording control operation according to the present embodiment is executed. Here, it is assumed that the partial removal of pre-recorded data by the front-part cutting unit 112 is performed when instructed recording is stopped.

In the present embodiment, a configuration is adopted such that, by writing data of pre-recording to the recording medium 107, which is used for instructed recording, the duration of the pre-recording period is not constrained by the capacity of the RAM 104. In FIG. 1, 1a shows recorded data in the recording medium 107 at the time point when instructed recording is started. Note that, in order to facilitate explanation and understanding, it is assumed here that there is no other recorded data in the recording medium 107.

When instructed recording is started, data of instruction-based recording is recorded to the recording medium 107 following data of pre-recording. In FIG. 1, 1b shows the state of recorded data in the recording medium 107 at the time point when instructed recording is stopped. Once instructed recording is stopped, the recording start position of pre-recorded data to be stored in association with instruction-based recorded data is identified. Here, it is assumed that the pre-recording period is set to three seconds. Subsequently, as 1c shows, data other than that corresponding to the pre-recording period is removed from pre-recorded data.

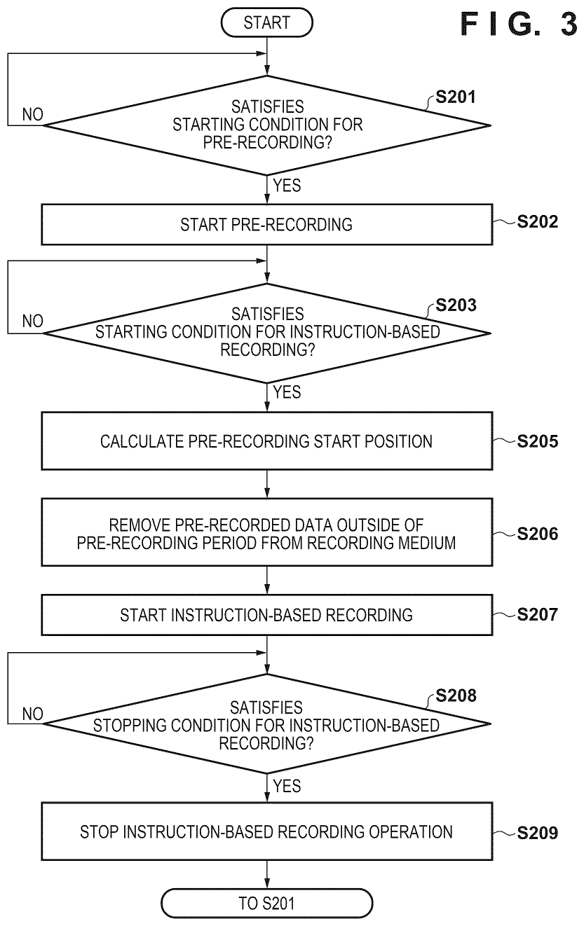

Next, the above-described data recording control operation during pre-recording and instructed recording will be described in further detail with reference to the flowchart shown in FIG. 3. This operation is executed in a state in which pre-recording is enabled. Furthermore, it is assumed that the removal of pre-recorded data other than that corresponding to the pre-recording period is executed when instructed recording is started.

Note that the digital camera 100 may execute appropriate known operations in regard to operations until the CPU 102 generates data to be recorded, such as operations relating to the capturing of a moving image or a still image. Thus, in the following, description will be provided focusing on an operation for controlling pre-recording and instructed recording of data generated by the CPU 102.

In step S201, the CPU 102 determines whether or not the pre-recording starting condition has been satisfied, and executes step S202 if it is determined that the pre-recording starting condition has been satisfied and otherwise executes step S201. As mentioned above, in the case of the moving-image mode for example, the pre-recording starting condition may be that the moving-image recording standby state (state in which a recording start instruction can be input) has been established. Furthermore, in the case of the still-image mode, the pre-recording starting condition may be that the half-press state of the release switch has been detected continuously over a predetermined amount of time without the release switch being placed in the full-press state. Note that the determination that the pre-recording starting condition has been satisfied may be made in response to pre-recording being enabled.

In step S202, the CPU 102 starts to generate data of pre-recording, and also provides the pre-recording processing unit 109 with a notification of the start of pre-recording. The pre-recording processing unit 109 starts to record data of pre-recording to the recording medium 107. Furthermore, the pre-recording processing unit 109 may provide the front-part cutting unit 112 with a notification relating to the recording start position of pre-recorded data.

In step S203, the CPU 102 determines whether or not the instructed-recording starting condition has been satisfied, and executes step S205 if it is determined that the instructed-recording starting condition has been satisfied and otherwise executes step S203 repeatedly.

In step S205, the CPU 102 starts to generate data of instruction-based recording data once the generation of data of pre-recording for the present frame is complete. Furthermore, the pre-recording start-position calculation unit 111 calculates information relating to the recording start position of pre-recorded data corresponding to the pre-recording period. The pre-recording start-position calculation unit 111 provides the pre-recording processing unit 109 and the front-part cutting unit 112 with a notification of the calculated information.

In step S206, the front-part cutting unit 112 removes data other than that corresponding to the pre-recording period from pre-recorded data in the recording medium 107.

In step S207, the instructed-recording processing unit 110 starts to record data of instruction-based recording to the recording medium 107.

In step S208, the CPU 102 determines whether or not the instructed-recording stopping condition has been satisfied, and executes step S209 if it is determined that the instructed-recording stopping condition has been satisfied and otherwise executes step S208 repeatedly.

In step S209, the CPU 102 stops the generation of data of instruction-based recording at the present frame. Furthermore, the CPU 102 provides the instructed-recording processing unit 110 with a notification of the stop of instructed recording. Upon receiving from the CPU 102 the notification of the stop of instructed recording, the instructed-recording processing unit 110 stops operating after recording data of instruction-based recording for the present frame. Subsequently, the CPU 102 executes step S201.

In such a manner, in the present embodiment, a configuration is adopted such that pre-recording is performed to a recording medium to which instructed recording is performed, and unnecessary pre-recorded data is removed from the recording medium after pre-recording is terminated. The capacity of the internal memory consumed by data of pre-recording is that necessary for the recording operation to the recording medium, and is not dependent on the duration of the pre-recording period. Thus, the constraint of the duration of the pre-recording period that would be imposed if data of pre-recording were buffered in the internal memory until pre-recording is terminated can be relaxed.

### Second Embodiment

Next, a second embodiment will be described. The present embodiment may be the same as the first embodiment with the exception of the operation relating to data recording control. Thus, description will be provided assuming that the second embodiment is implemented on the digital camera 100 described earlier.

In the first embodiment, pre-recorded data in the recording medium 107 continues to increase during the execution of pre-recording and reduces the free space in the recording medium 107. In the present embodiment, a decrease in the free space in the recording medium 107 due to pre-recorded data is suppressed.

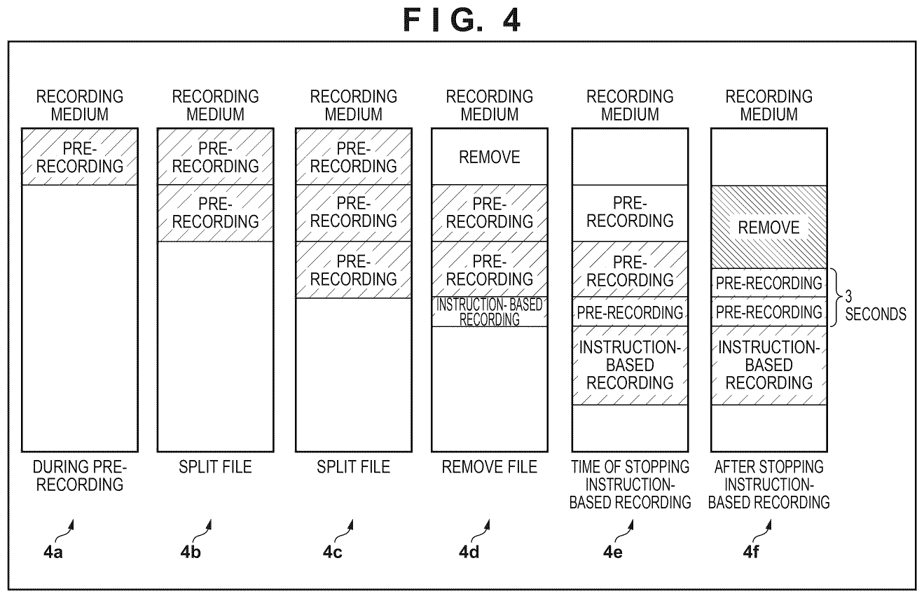

FIG. 4 is a diagram schematically illustrating the change over time of pre-recorded data and instruction-based recorded data in the recording medium 107 when the recording control operation according to the present embodiment is executed. Here, it is assumed that the partial removal of pre-recorded data by the front-part cutting unit 112 is performed when instructed recording is stopped.

In the present embodiment, a configuration is adopted such that, by writing data of pre-recording to the recording medium 107, which is used for instructed recording, the duration of the pre-recording period is not constrained by the capacity of the RAM 104, as was the case in the first embodiment. Illustrated in 4a is the state of pre-recorded data in the recording medium 107 after the elapse of a predetermined amount of time from the start of pre-recording. Note that, in order to facilitate explanation and understanding, it is assumed here that there is no other recorded data in the recording medium 107.

When pre-recording is continued and the amount of pre-recorded data stored in a file reaches a predetermined threshold Th1, the file is split into a plurality of files storing the data amount corresponding to the threshold Th1 in a distributed manner. Specifically, when the amount of pre-recorded data stored in a file reaches the predetermined threshold Th1, the pre-recording processing unit 109 splits the file into two files of the same size (Th1/2) storing pre-recorded data (4b). Furthermore, the pre-recording processing unit 109 continues to record data of pre-recording to a newly generated file. So that each of the files obtained by the splitting can store pre-recorded data having a length longer than or equal to the pre-recording period, Th1 is determined so as to be greater than twice the data amount corresponding to the pre-recording period (Th1 is set so as to satisfy Th1>2×(data amount corresponding to pre-recording period)).

Subsequently, in the same manner, the pre-recording processing unit 109 splits the file being presently recorded each time the amount of pre-recorded data stored in the file reaches the threshold Th1, and continues recording data of pre-recording to a new file (4c). Furthermore, once the total amount of pre-recorded data reaches a predetermined threshold Th2, the pre-recording processing unit 109 (or the front-part cutting unit 112) removes the file storing the oldest pre-recorded data at present (4d). For example, the threshold Th2 can be determined as Th2≥threshold Th1/2×α+(data amount corresponding to pre-recording period). Here, α is a predetermined integer of 2 or greater.

When instructed recording is started, data of instruction-based recording is recorded to the recording medium 107 following data of pre-recording. Illustrated in 4e is the state of recorded data in the recording medium 107 at the time point when instructed recording is stopped. Once instructed recording is stopped, the recording start position of pre-recorded data to be stored in association with instruction-based recorded data is identified. Here, it is assumed that the pre-recording period is set to three seconds. Subsequently, as illustrated in 4f, data other than that corresponding to the pre-recording period is removed from pre-recorded data by the front-part cutting unit 112. The section to be removed by the front-part cutting unit 112 can be identified in the same manner as in the first embodiment.

Note that, while the thresholds Th1 and Th2 are described as being data amounts here, a recording time or number of frames may be adopted in place of a data amount. For example, a configuration is adopted such that a file is split each time pre-recording is executed for a predetermined amount of time or number of frames (threshold Th1), and, when the total amount of pre-recorded data equals a predetermined amount of time or number of frames (threshold Th2), the file storing the oldest pre-recorded data at present is removed. Note that the recording time [sec] may be calculated by dividing the recorded number of frames by the frame rate [fps]. Information such as the data amount, recording time, and/or number of frames relating to pre-recording is monitored and managed by the pre-recording processing unit 109.

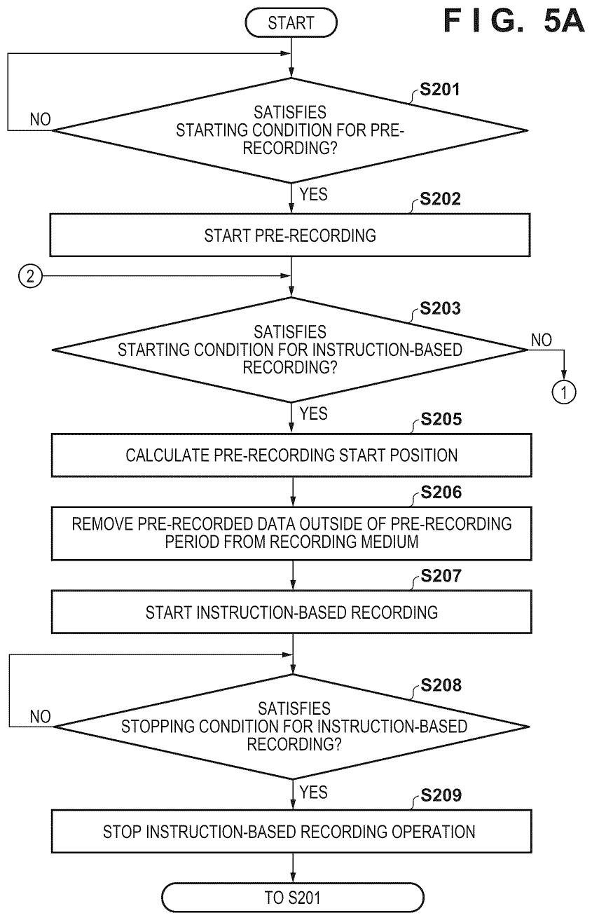

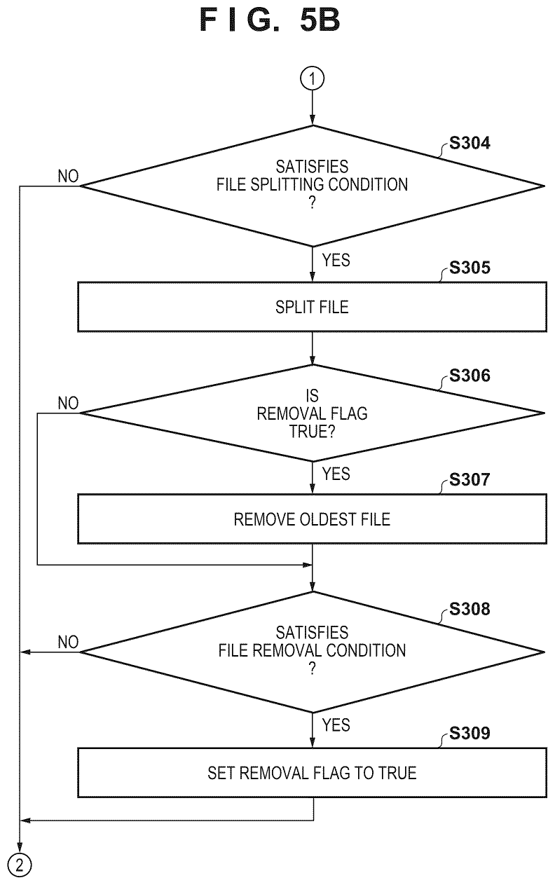

Next, the above-described data recording control operation during pre-recording and instructed recording will be described in further detail with reference to the flowcharts shown in FIGS. 5A and 5B. This operation is executed in a state in which pre-recording is enabled. Furthermore, it is assumed here that the removal of pre-recorded data other than that corresponding to the pre-recording period is executed when instructed recording is started. Furthermore, the same reference numerals as those in FIG. 3 are provided to steps in which the same processing as that in the first embodiment is executed, and redundant description thereof is omitted.

Description regarding steps S201 and S202 is omitted. In step S203, the CPU 102 determines whether or not the instructed-recording starting condition has been satisfied, and executes step S205 if it is determined that the instructed-recording starting condition has been satisfied and otherwise executes step S304.

In step S304, the pre-recording processing unit 109 determines whether or not a file splitting condition has been satisfied, and executes step S305 if it is determined that the file splitting condition has been satisfied and otherwise returns processing to step S203. Here, the file splitting condition is the condition based on the threshold Th1 relating to the amount, recording time, or recorded number of frames of pre-recorded data, which has been described with reference to FIG. 4. If it is determined that the file splitting condition has been satisfied, the pre-recording processing unit 109 resets the data amount, recording time, or number of frames used for the determination. Thus, the processing in and following step S305 is executed each time it is determined that the file splitting condition has been satisfied during pre-recording.

In step S305, the pre-recording processing unit 109 divides the file having satisfied the file splitting condition into two files via the recording-medium control unit 108. Furthermore, the pre-recording processing unit 109 generates a new file via the recording-medium control unit 108, and changes the recording destination of data of pre-recording to the new file.

In step S306, the pre-recording processing unit 109 determines whether or not a removal flag indicating whether or not the oldest one among files storing pre-recorded data is to be removed indicates true (1) or false (0). For example, the removal flag can be held in the RAM 102 during pre-recording. The pre-recording processing unit 109 executes step S307 if it is determined that the removal flag indicates true, and otherwise executes step S308.

In step S307, the pre-recording processing unit 109 removes, via the recording-medium control unit 108, the oldest one at present among files storing pre-recorded data. The pre-recording processing unit 109 executes step S308 after changing the removal flag to false.

In step S308, the pre-recording processing unit 109 determines whether or not a file removal condition has been satisfied, and executes step S309 if it is determined that the file removal condition has been satisfied and otherwise returns processing to step S203. Here, the file removal condition is the condition based on the threshold Th2 relating to the amount, recording time, or recorded number of frames of pre-recorded data, which has been described with reference to FIG. 4. If it is determined that the file removal condition has been satisfied, the pre-recording processing unit 109 resets the data amount, recording time, or number of frames used for the determination. Thus, step S309 is executed each time it is determined that the file removal condition has been satisfied during pre-recording.

In step S309, the pre-recording processing unit 109 returns processing to step S203 after setting the removal flag to true.

Note that the operations in and following step S205 are the same as those in the first embodiment, with the exception of there being cases in which pre-recorded data removed by the front-part cutting unit 112 in step S206 and pre-recorded data corresponding to the pre-recording period are recorded spanning across multiple data files. If pre-recorded data corresponding to the pre-recording period is recorded spanning across multiple data files, a data file in which instruction-based recorded data is stored and the multiple data files storing pre-recorded data corresponding to the pre-recording period are associated. The method of association may be the same as that in the first embodiment.

According to the present embodiment, the same effect as that of the first embodiment can be achieved by performing pre-recording to a recording medium that is used for instructed recording. Furthermore, because a limit is imposed on the maximum amount of pre-recorded data in the recording medium, the free space in the recording medium during pre-recording can be prevented from decreasing any more than a predetermined amount.

### Third Embodiment

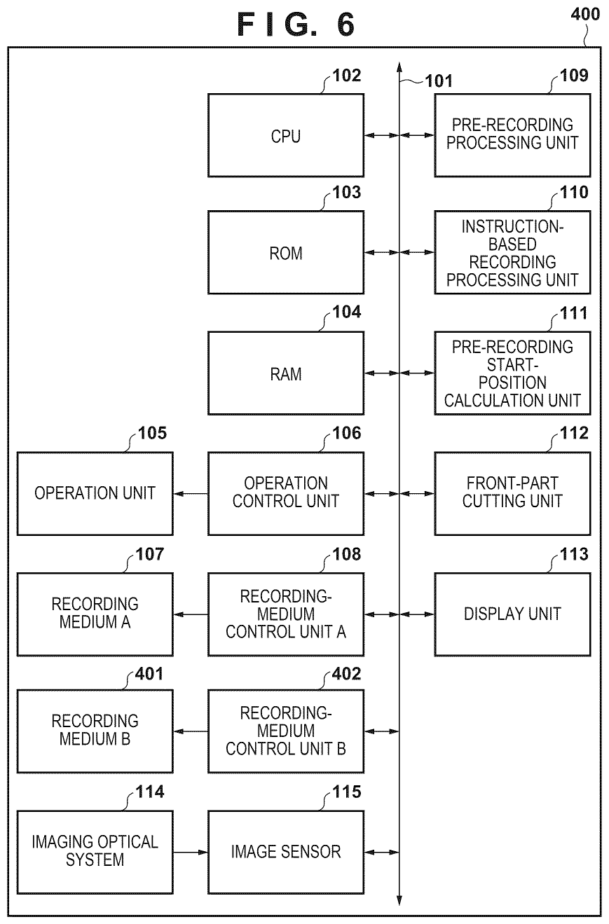

Next, a third embodiment will be described. The present embodiment is directed to an image recording apparatus that can use a plurality of recording media for instructed recording. FIG. 6 is a block diagram illustrating an example of a functional configuration of a digital camera 400, which is an example of an image recording apparatus according to the present embodiment. In FIG. 6, the same reference numerals as those in FIG. 2 are provided to functional blocks that are the same as those in the digital camera 100, and redundant description thereof is omitted.

The digital camera 400 can use two recording media (recording medium A 107 and recording medium B 401). Furthermore, the digital camera 400 includes recording medium control unit A 108 that controls the reading and writing of data from and to recording medium A 107, and recording medium control unit B 402 that controls the reading and writing of data from and to recording medium B 401. Note that recording medium A 107 and recording medium B 401 may each be the same as the recording medium 107 included in the digital camera 100. Furthermore, recording medium control unit A 108 and recording medium control unit B 402 may each be the same as the recording-medium control unit 108 included in the digital camera 100.

Furthermore, in the present embodiment, the pre-recording processing unit 109 periodically acquires the free space in each recording medium from recording medium control unit A 108 and recording medium control unit B 402 during pre-recording to manage the remaining capacity of a pre-recording area in each recording medium. Furthermore, in accordance with the start timing of instructed recording, the pre-recording processing unit 109 determines the recording medium that starts instructed recording.

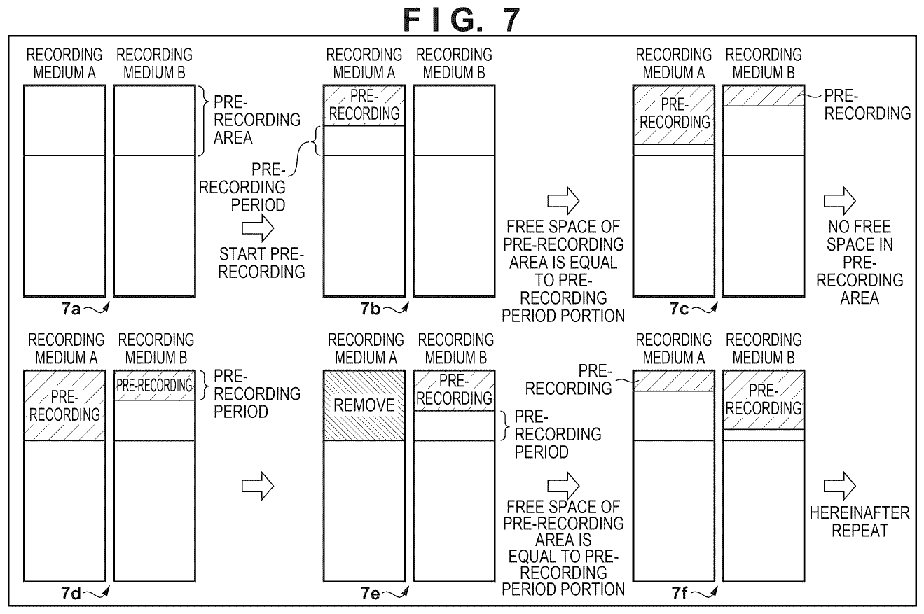

FIG. 7 is a diagram schematically illustrating the change over time of pre-recorded data in recording medium A 107 and recording medium B 401 when the recording control operation according to the present embodiment is executed. Note that, in order to facilitate explanation and understanding, it is assumed here that there is no other recorded data in recording medium A 107 or recording medium B 401.

In the present embodiment, the pre-recording processing unit 109 sets in advance an area for pre-recording (pre-recording area) in part of the recording area of each of recording medium A 107 and recording medium B 401 (7a). The pre-recording processing unit 109 records data of pre-recording only to the pre-recording area. The pre-recording area is set to a size in which data of pre-recording can be recorded over a period that is longer than the pre-recording period.

At the start of pre-recording, data of pre-recording is recorded to one of recording medium A 107 and recording medium B 401 (recording medium A 107 in this example). Illustrated in 7b is the state of pre-recorded data in recording medium A 107 and recording medium B 401 at a time point when a parallel-recording starting condition has been satisfied following the start of pre-recording. The parallel-recording starting condition may be that the free space in the pre-recording area has equaled that corresponding to the pre-recording period in one of recording medium A 107 and recording medium B 401. The free space can be represented as a time, data amount, or number of frames for which recording can be performed.

At the time point illustrated in 7b, data of pre-recording has been recorded only in recording medium A 107. Thus, illustrated in 7b is a state in which the free space in recording medium A 107 has equaled that corresponding to the pre-recording period.

Once the parallel-recording starting condition is satisfied, the pre-recording processing unit 109 records data of pre-recording in parallel to both recording medium A 107 and recording medium B 401 (7c). Due to this, at the time point (7d) at which the free space in the pre-recording area of one of recording medium A 107 and recording medium B 401 has been exhausted, a state is established in which the most recent data of pre-recording corresponding to the pre-recording period has been recorded to both recording medium A 107 and recording medium B 401. Thus, a situation in which the most recent data of pre-recording corresponding to the pre-recording period is recorded spanning across the two recording media can be prevented.

Once the free space in the pre-recording area of one of recording medium A 107 and recording medium B 401 is exhausted, the pre-recording processing unit 109 removes pre-recorded data in the pre-recording area whose free space has been exhausted, and stops the recording of data of pre-recording to the corresponding recording medium. Note that the pre-recording processing unit 109 continues to record data of pre-recording to the recording medium in which there is free space (recording medium B 401 in this example) also during this removal of pre-recorded data,

Thereafter, once the parallel-recording starting condition is satisfied for recording medium B 401 to which data of pre-recording is continuously recorded (7e), the pre-recording processing unit 109 records data of pre-recording in parallel to both recording medium A 107 and recording medium B 401 (7f).

Thereafter, during the execution of pre-recording, the pre-recording processing unit 109 repeats control in which: when the free space in a pre-recording area is exhausted, parallel recording is stopped and pre-recorded data in the pre-recording area whose free space has been exhausted is removed; and parallel recording is started once the parallel-recording starting condition is satisfied.

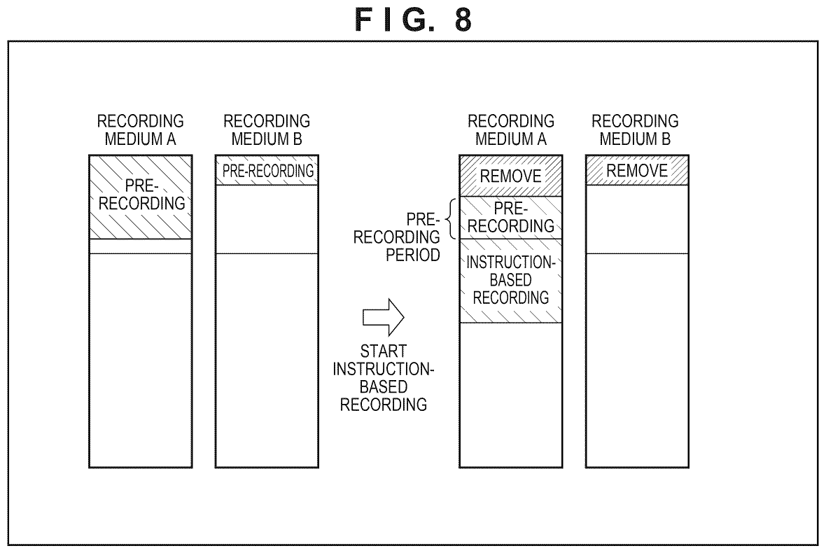

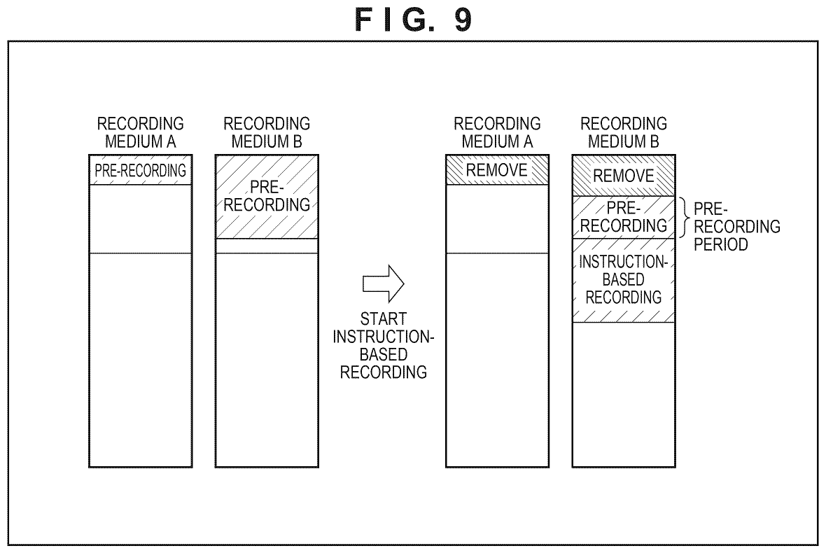

Next, the recording control operation when instructed recording is started will be described with reference to FIGS. 8 and 9. FIGS. 8 and 9 both illustrate the recording control operation when instructed recording is started during parallel recording, and are the same with the exception of the recording medium that has satisfied the parallel-recording starting condition.

First, FIG. 8 will be described. If it is determined that the instructed-recording starting condition has been satisfied, the CPU 102 provides the pre-recording processing unit 109 and the instructed-recording processing unit 110 with a notification of the start of instructed recording. Upon receiving the notification of the start of instructed recording, the pre-recording processing unit 109, in addition to executing the processing described earlier, determines the recording medium that starts instructed recording and provides the pre-recording start-position calculation unit 111 and the instructed-recording processing unit 110 with a notification thereof.

As illustrated in FIG. 8, if it is determined that the instructed-recording starting condition has been satisfied during parallel recording, the pre-recording processing unit 109 determines the recording medium in which there is less free space in the pre-recording area (recording medium A 107 in this example) as the recording medium that starts instructed recording. This is because, at timings during the execution of parallel recording, data of the entire pre-recording period is present only in the recording medium in which there is less free space in the pre-recording area. Accordingly, it can be said, in other words, that the pre-recording processing unit 109 determines the recording medium in which data of the entire pre-recording period is present as the recording medium that starts instructed recording.

Furthermore, if it is determined that the instructed-recording starting condition has been satisfied at a timing when pre-recording is being performed to only one of the recording media, the pre-recording processing unit 109 determines the recording medium to which pre-recording is being performed as the recording medium that starts instructed recording.

Note that the pre-recording processing unit 109 need not determine the recording medium that starts instructed recording when instructed recording is started. For example, the pre-recording processing unit 109 can hold, in the RAM 104 for example, identification information of the recording medium that starts instructed recording. It is sufficient that the pre-recording processing unit 109: hold identification information of the recording medium in which there is less free space in the pre-recording area as the recording medium that starts instructed recording during parallel recording; and hold identification information of the recording medium to which pre-recording is being performed as the recording medium that starts instructed recording in a state in which parallel recording is not being performed. Specifically, if there are two recording media, it is sufficient that the pre-recording processing unit 109 switch the recording medium indicated by the identification information when parallel recording is terminated.

Furthermore, the pre-recording processing unit 109 removes pre-recorded data present in the recording medium (recording medium B 401 in this example) other than the recording medium that starts instructed recording.

The instructed-recording processing unit 110 starts instructed recording to the recording medium (recording medium A 107 in this example) in the notification from the pre-recording processing unit 109. Furthermore, in a similar manner as in the first embodiment, the pre-recording start-position calculation unit 111 and the front-part cutting unit 112 remove pre-recorded data other than data corresponding to the pre-recording period from the recording medium used to start instructed recording.

Similar control is executed also in the example in FIG. 9, in which the states of the pre-recorded data in recording medium A 107 and recording medium B 401 at the time point when the instructed-recording starting condition is satisfied is the reverse of that in FIG. 8.

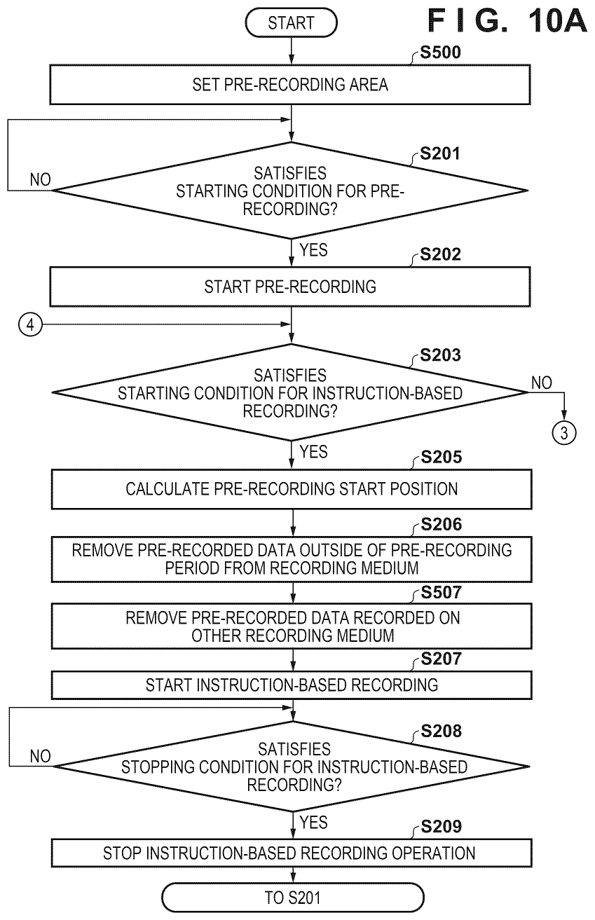

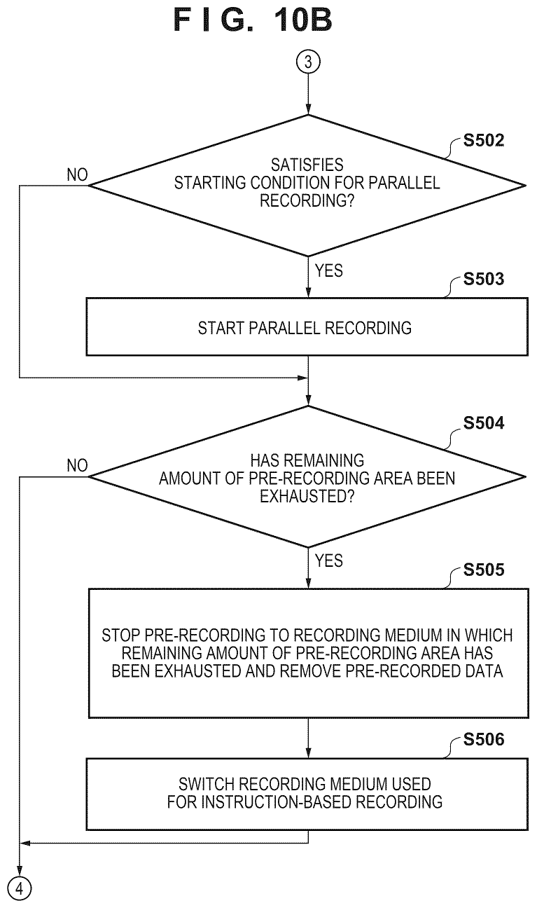

Next, the data recording control operation during pre-recording and instructed recording described above in relation to FIGS. 7 to 9 will be described in further detail with reference to the flowcharts shown in FIGS. 10A and 10B. This operation is executed in a state in which pre-recording is enabled. Furthermore, it is assumed that the removal of pre-recorded data other than that corresponding to the pre-recording period is executed when instructed recording is started. Furthermore, the same reference numerals as those in FIG. 3 are provided to steps in which the same processing as that in the first embodiment is executed, and redundant description thereof is omitted.

In step S500, the pre-recording processing unit 109 sets a pre-recording area in each of recording medium A 107 and recording medium B 401. Note that the setting of the pre-recording area can be executed at any appropriate time point before pre-recording is started and after the duration of the pre-recording period has been set.

Description regarding steps S201 and S202 is omitted. In step S203, the CPU 102 determines whether or not the instructed-recording starting condition has been satisfied, and executes step S205 if it is determined that the instructed-recording starting condition has been satisfied and otherwise executes step S502.

In step S502, the pre-recording processing unit 109 determines whether or not the parallel-recording starting condition has been satisfied, and executes step S503 if it is determined that the parallel-recording starting condition has been satisfied and otherwise executes step S504. As mentioned above, the parallel-recording starting condition may be that the free space in the pre-recording area has equaled that corresponding to the pre-recording period in one of recording medium A 107 and recording medium B 401. The free space in the pre-recording area can be detected according to any appropriate method, such as comparing the capacity of the pre-recording area and a cumulative value of the data amount recorded in the recording medium or the amount of change in the free space in the recording medium, for example.

In step S503, the pre-recording processing unit 109 starts parallel recording. This results in data of pre-recording being recorded in parallel to both recording medium A 107 and recording medium B 401.

In step S504, the pre-recording processing unit 109 determines whether or not the free space in the pre-recording area of one of the recording media has been exhausted, and executes step S505 if it is determined that the free space has been exhausted and otherwise returns processing to step S203.

In step S505, the pre-recording processing unit 109 stops pre-recording to the recording medium in which the free space in the pre-recording area has been exhausted. Furthermore, the pre-recording processing unit 109 removes pre-recorded data from the pre-recording area whose free space has been exhausted. Subsequently, the pre-recording processing unit 109 executes step S506.

In step S506, the pre-recording processing unit 109 switches the recording medium that starts instructed recording from the recording medium pre-recording to which has been stopped to the recording medium pre-recording to which is presently being continued. As mentioned above, the recording medium that starts the instructed recording may be determined when instructed recording is started. Subsequently, the pre-recording processing unit 109 returns processing to step S203.

After pre-recorded data is removed by the front-part cutting unit 112 in step S206, in step S507, the pre-recording processing unit 109 removes pre-recorded data present in the recording medium other than the recording medium that starts instructed recording. Note that this removal processing may be executed after instructed recording is stopped.

In step S207, the instructed-recording processing unit 110 starts instructed recording onto the recording medium that starts instructed recording among the plurality of recording media. The processing following this point is similar to that in the first embodiment, and description thereof is thus omitted. Note that, if the free space in the recording medium that has started instructed recording is exhausted, instructed recording may be continued onto a different recording medium (relay recording).

According to the present embodiment, the same effect as that of the first embodiment can be achieved even if there are a plurality of recording media that can be used for instructed recording. Furthermore, because a configuration is adopted such that a pre-recording area is set in each recording medium and data of pre-recording is recorded only to the pre-recording area, the proportion of recording media occupied by pre-recorded data can be suppressed. Furthermore, by controlling pre-recording so that pre-recorded data of the entire pre-recording period is present in one recording medium at all times, pre-recorded data corresponding to the pre-recording period is reliably recorded in the same recording medium as that to which instruction-based recorded data is recorded regardless of the start timing of instructed recording.

### Fourth Embodiment

Next, a fourth embodiment will be described. Similarly to the third embodiment, the present embodiment is directed to an image recording apparatus that can use a plurality of recording media for instructed recording. Furthermore, the present embodiment may be the same as the third embodiment with the exception of the operation relating to data recording control. Thus, description will be provided assuming that the fourth embodiment is implemented on the digital camera 400 described earlier.

In the third embodiment, the digital camera 400 (pre-recording processing unit 109) dynamically determines the recording medium that starts instructed recording. The present embodiment relates to recording control in a case in which the recording medium that starts instructed recording is set in advance. The recording control until instructed recording is started may be the same as that in the third embodiment.

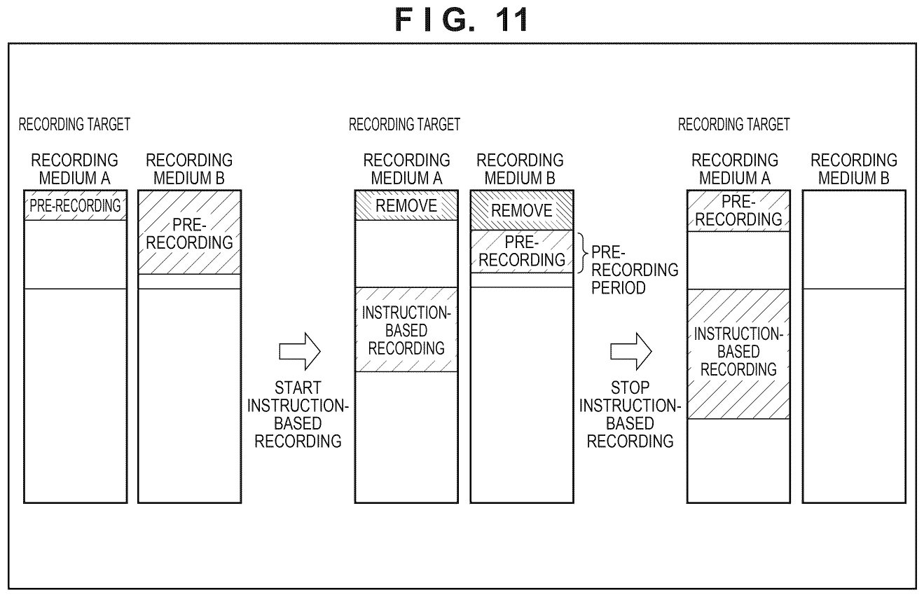

FIG. 11 schematically illustrates the recording control operation in the present embodiment in a case in which instructed recording is started from the same state as that in FIG. 9. However, it is assumed that recording medium A 107 is set in advance as the recording medium that starts instructed recording. Note that the setting of the recording medium that starts instructed recording may be a setting that the user can change via the menu screen for example, or may be a setting that is based on the specifications of the digital camera 400 and cannot be changed for example. It is assumed that the setting of the recording medium that starts instructed recording is stored in the ROM 103.

Upon receiving a notification of the start of instructed recording, the instructed-recording processing unit 110 starts instructed recording onto the set recording medium. If pre-recorded data of the entire pre-recording period is present in the recording medium that starts instructed recording, the instructed-recording processing unit 110 executes the same recording control operation as that in the third embodiment for instructed recording as well. On the other hand, if the recording medium that starts instructed recording and the recording medium in which pre-recorded data of the entire pre-recording period is present are different, the instructed-recording processing unit 110 executes instructed recording while avoiding the pre-recording area set in the recording medium that starts instructed recording, as illustrated in FIG. 11. Note that, while unnecessary pre-recorded data is removed when instructed recording is started in FIG. 11, the removal may be performed after instructed recording is stopped.

Once instructed recording is stopped, the instructed-recording processing unit 110 copies pre-recorded data of the entire pre-recording period recorded in the other recording medium to the pre-recording area of the recording medium that has started instructed recording. Furthermore, once the copying is complete, the instructed-recording processing unit 110 removes the copy-source pre-recorded data.

Thus, pre-recorded data corresponding to the pre-recording period and instruction-based recorded data are reliably stored in the same recording medium regardless of the setting of the recording medium that starts instructed recording and the start timing of instructed recording.

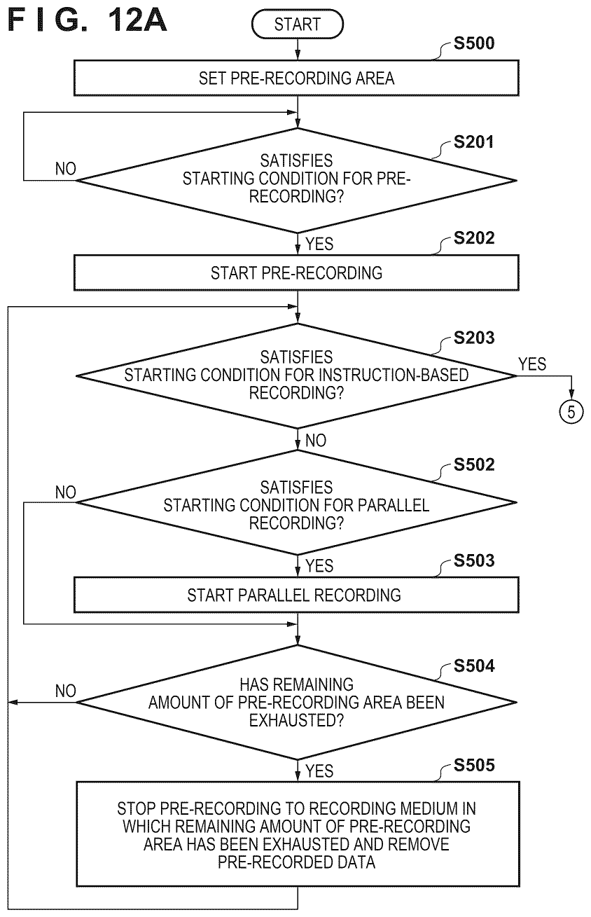

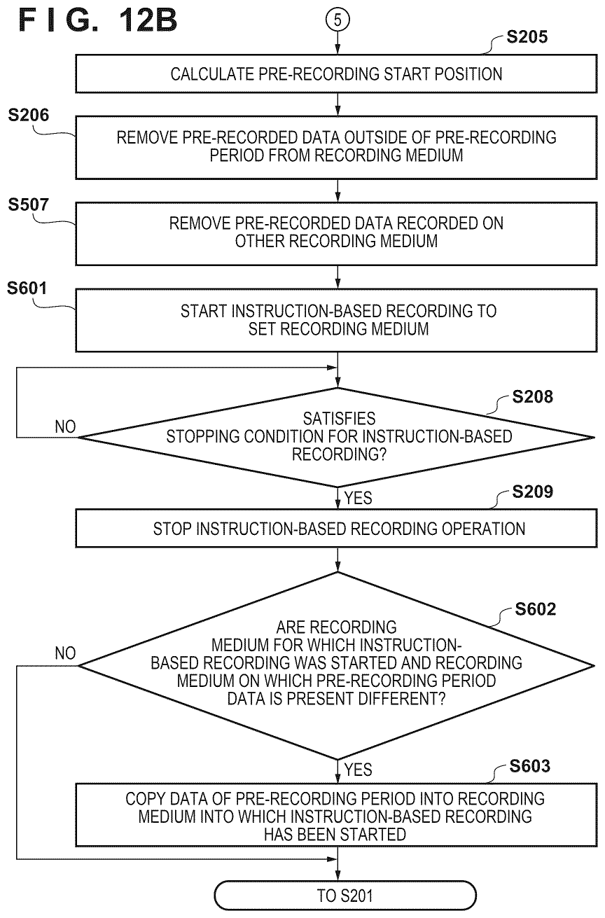

Next, the data recording control operation during pre-recording and instructed recording in the present embodiment will be described in further detail with reference to the flowcharts shown in FIGS. 12A and 12B. This operation is executed in a state in which pre-recording is enabled. Furthermore, it is assumed that the removal of pre-recorded data other than that corresponding to the pre-recording period is executed when instructed recording is started. Furthermore, the same reference numerals as those in FIG. 3 are provided to steps in which the same processing as that in the first embodiment is executed, the same reference numerals as those in FIGS. 10A and 10B are provided to steps in which the same processing as that in the third embodiment is executed, and redundant description thereof is omitted.

Description regarding steps S500, S201, and S202 is omitted. In step S203, the CPU 102 determines whether or not the instructed-recording starting condition has been satisfied, and executes step S205 if it is determined that the instructed-recording starting condition has been satisfied and otherwise executes step S502. The recording control operation during pre-recording in steps S502 to S505 is similar to that in the third embodiment, and description thereof is thus omitted.

Description regarding steps S205, S206, and S507 is omitted. In step S601, the instructed-recording processing unit 110 refers to the ROM 103 for example, and starts instructed recording onto the recording medium set as the recording medium that starts instructed recording.

Note that, if the instructed-recording start position identified based on information in a notification from the pre-recording processing unit 109 is a position in the recording medium that starts instructed recording, the instructed-recording processing unit 110 starts instructed recording from the start position based on the notification. On the other hand, if the instructed-recording start position identified based on information in the notification from the pre-recording processing unit 109 is a position in a recording medium different from the recording medium that starts instructed recording, the instructed-recording processing unit 110 starts instructed recording from a start position that is not based on the notification. For example, the instructed-recording processing unit 110 starts instructed recording from the free area at the beginning of the recording medium that starts instructed recording, excluding the pre-recording area.

Once instructed recording is stopped, in step S602, the instructed-recording processing unit 110 determines whether or not the recording medium that has started instructed recording and the recording medium in which pre-recorded data corresponding to the pre-recording period is present are different, and executes step S603 if it is determined that the recording media are different and otherwise returns processing to step S201.

In step S603, the instructed-recording processing unit 110 copies pre-recorded data of the entire pre-recording period recorded in the other recording medium to the pre-recording area of the recording medium that has started instructed recording. Furthermore, once the copying is complete, the instructed-recording processing unit 110 removes the copy-source pre-recorded data. Subsequently, the instructed-recording processing unit 110 returns processing to step S201.

According to the present embodiment, the same effect as that of the third embodiment can be achieved even if the recording media to be used for instructed recording is set in advance.

### Fifth Embodiment

Next, a fifth embodiment will be described. The present embodiment may be the same as the first embodiment with the exception of the operation relating to data recording control. Thus, description will be provided assuming that the fifth embodiment is implemented on the digital camera 100 described earlier.

In the second embodiment, a decrease in free space in the recording medium 107 due to pre-recorded data is suppressed by removing the file storing the oldest pre-recorded data at present once the total amount of pre-recorded data present in the recording medium 107 reaches a threshold during pre-recording. In the present embodiment, a decrease in free space in the recording medium 107 due to pre-recording is suppressed by, if a specific condition is satisfied, executing conventional pre-recording in which data of pre-recording corresponding to the pre-recording period is buffered in the RAM 104 without recording data to the recording medium 107 during pre-recording.

Here, the specific condition for executing the conventional pre-recording may be one or more of the following conditions: if there is not much free space in the recording medium 107 (no more than a capacity threshold) at the time point when pre-recording is started; and if the pre-recording period is short (no longer than a time threshold). Note that these conditions are mere examples, and other conditions may be adopted. Furthermore, it is assumed that the capacity threshold and the time threshold are set in the ROM 103 in advance.

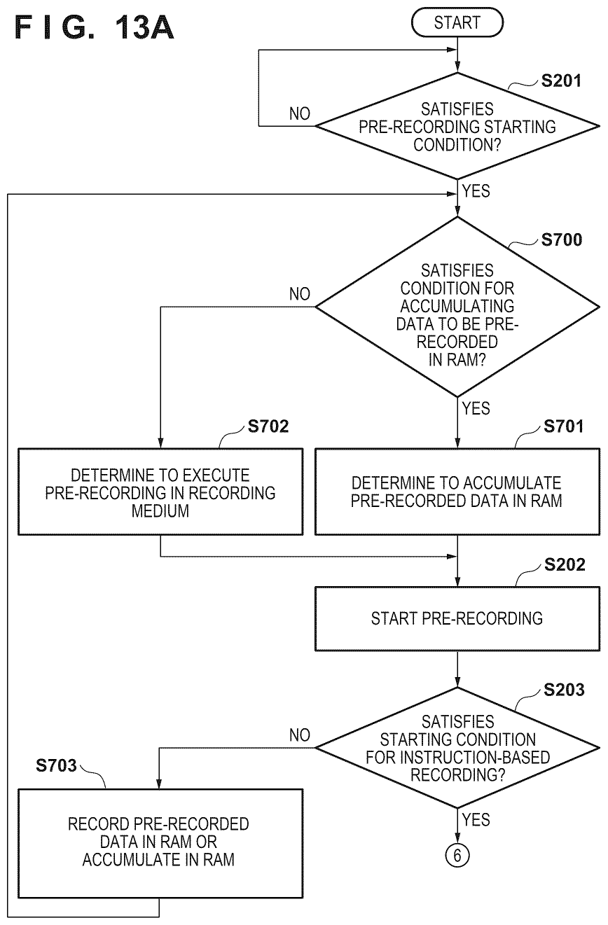

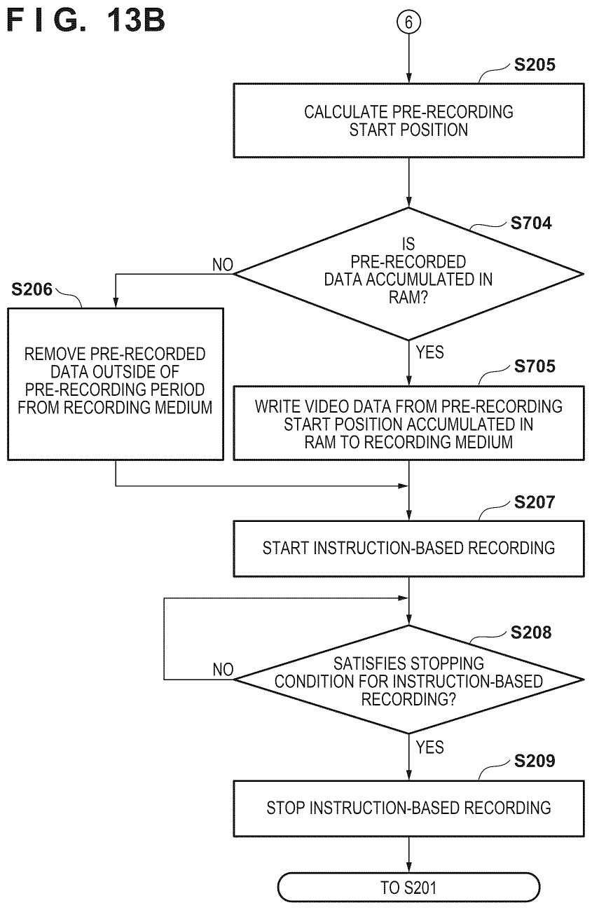

The data recording control operation during pre-recording and instructed recording according the present embodiment will be described in further detail with reference to the flowcharts shown in FIGS. 13A and 13B. This operation is executed in a state in which pre-recording is enabled. Furthermore, it is assumed here that the removal of pre-recorded data other than that corresponding to the pre-recording period is executed when instructed recording is started. Furthermore, the same reference numerals as those in FIG. 3 are provided to steps in which the same processing as that in the first embodiment is executed, and redundant description thereof is omitted.

In step S201, the CPU 102 determines whether or not the pre-recording starting condition has been satisfied, and executes step S700 if it is determined that the pre-recording starting condition has been satisfied and otherwise executes step S201.

In step S700, the pre-recording processing unit 109 determines whether or not the condition for accumulating data of pre-recording in the RAM 104 has been satisfied, and executes step S701 if it is determined that the condition has been satisfied and otherwise executes step S702. It can be said that this determination is a determination of whether to execute the conventional pre-recording method or the pre-recording method according to the first embodiment.

For example, the pre-recording processing unit 109 determines that the condition for accumulating data of pre-recording in the RAM 104 is satisfied if the free space in the recording medium 107 obtained from the recording-medium control unit 108 is no more than the capacity threshold or the pre-recording period is no longer than the time threshold. Furthermore, the pre-recording processing unit 109 does not determine that the condition for accumulating data of pre-recording in the RAM 104 is satisfied if the free space in the recording medium 107 is more than the capacity threshold and the pre-recording period is longer than the time threshold.

Alternatively, the pre-recording processing unit 109 determines whether or not the condition is satisfied based on the capacity of the storage area in the RAM 104 in which data of pre-recording can be accumulated and the duration of the pre-recording period. In this case, for example, the pre-recording processing unit 109 calculates the maximum duration of data of pre-recording (moving image) that can be accumulated in the RAM 104 based on recording settings including the recording size (number of recorded pixels per frame), recording format, compressing settings, etc., of moving-image data. Furthermore, the pre-recording processing unit 109 determines that the condition for accumulating the data of pre-recording in the RAM 104 is satisfied if the duration of the pre-recording period is no longer than the calculated maximum duration of data that can be accumulated. On the other hand, the pre-recording processing unit 109 does not determine that the condition for accumulating the data of pre-recording in the RAM 104 is satisfied if the duration of the pre-recording period is longer than the calculated maximum duration of data that can be accumulated. Note that, in place of calculating the maximum duration of moving-image data that can be accumulated in the RAM 104 based on recording settings, the maximum duration of moving-image data that can be accumulated in the RAM 104 may be held in the ROM 103 in advance in correspondence with different combinations of recording settings.

In step S701, the pre-recording processing unit 109 determines to execute the conventional pre-recording method (i.e., to accumulate (temporarily store) data corresponding to the most recent pre-recording period in the RAM 104 without recording data of pre-recording to the recording medium 107 during pre-recording).

In step S702, the pre-recording processing unit 109 determines to execute the pre-recording method according to the first embodiment (i.e., to sequentially record data of pre-recording to the recording medium 107 during pre-recording).

Note that the pre-recording processing unit 109 stores, in the RAM 104 for example, the result of the determination in step S701 or S702 for at least the two most recent instances of the determination.

Subsequently, pre-recording is started in step S202, and, during pre-recording, the pre-recording processing unit 109 accumulates data of pre-recording in the RAM 104 or records data of pre-recording to the recording medium 107 in step S703 in accordance with the most recently executed determination in step S701 or S702. Note that, in a case in which data of pre-recording is accumulated in the RAM 104, data of pre-recording in the RAM 104 is sequentially updated so that data of pre-recording corresponding to the most recent pre-recording period is buffered and held in the RAM 104. Thus, the capacity of the RAM 104 consumed by data of pre-recording is dependent on the pre-recording period.

After the instructed-recording starting condition is satisfied, the pre-recording processing unit 109 determines whether or not data of pre-recording is accumulated in the RAM 104 in step S704. The pre-recording processing unit 109 executes step S705 if it is determined that data of pre-recording is accumulated in the RAM 104, and otherwise advances processing to step S206. The determination in step S704 corresponds to a determination of whether or not the conventional pre-recording method was being executed at the time point when the instructed-recording starting condition was satisfied.

In step S705, the pre-recording processing unit 109 records the data of pre-recording accumulated in the RAM 104 to the recording medium 107. The processing in and following steps S206 and S207 is the same as that in the first embodiment, and description thereof is thus omitted.

According to the present embodiment, it can be dynamically switched, in accordance with a predetermined condition, whether to accumulate (temporarily store) data of pre-recording in the internal memory or to record data of pre-recording to the recording medium used for instructed recording. Thus, in a case such as when there is a demand to prioritize the securing of free space in the recording medium used for instructed recording or the capacity in the internal memory is enough in relation to the duration of the pre-recording period, for example, the number of accesses made to the recording medium can be reduced by accumulating data of pre-recording in the internal memory. Furthermore, a situation can be prevented in which pre-recording is interrupted due to the free space in the recording medium being exhausted during the pre-recording period.

### Sixth Embodiment

Next, a sixth embodiment will be described. The present embodiment may be the same as the fifth embodiment with the exception of the operation relating to data recording control. Thus, description will be provided assuming that the fifth embodiment is implemented on the digital camera 100 described earlier.

In the fifth embodiment, in a case in which a change in setting that affects the determination in step S700 is made during pre-recording, pre-recording may be executed inappropriately if the result of the determination in step S700 were based on the setting before the change. For example, a case in which the setting of the duration of the pre-recording period is changed during pre-recording, etc., are conceivable.

Thus, in the present embodiment, the pre-recording method is repeatedly determined during pre-recording and the pre-recording method is dynamically switched as necessary so that pre-recording that is suitable for the present settings can be executed.

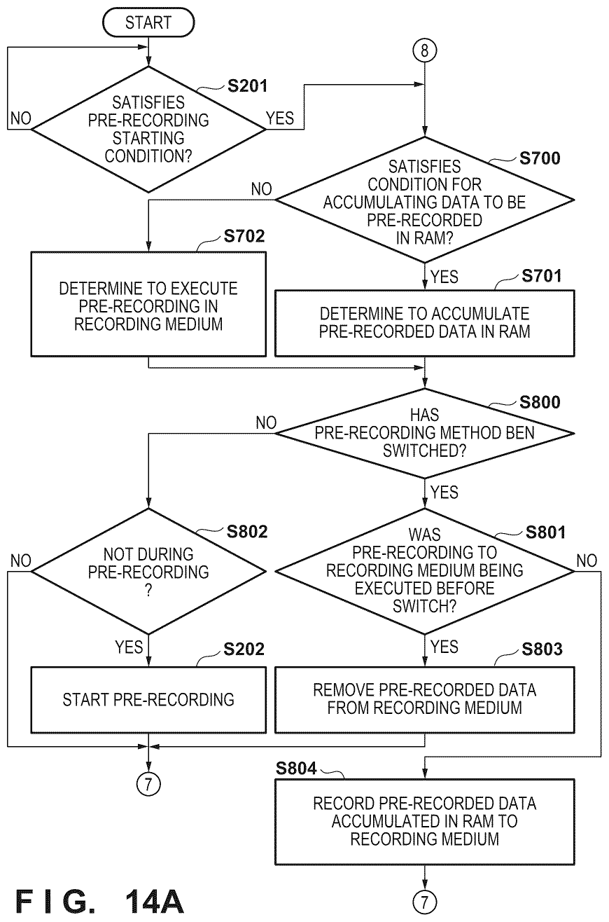

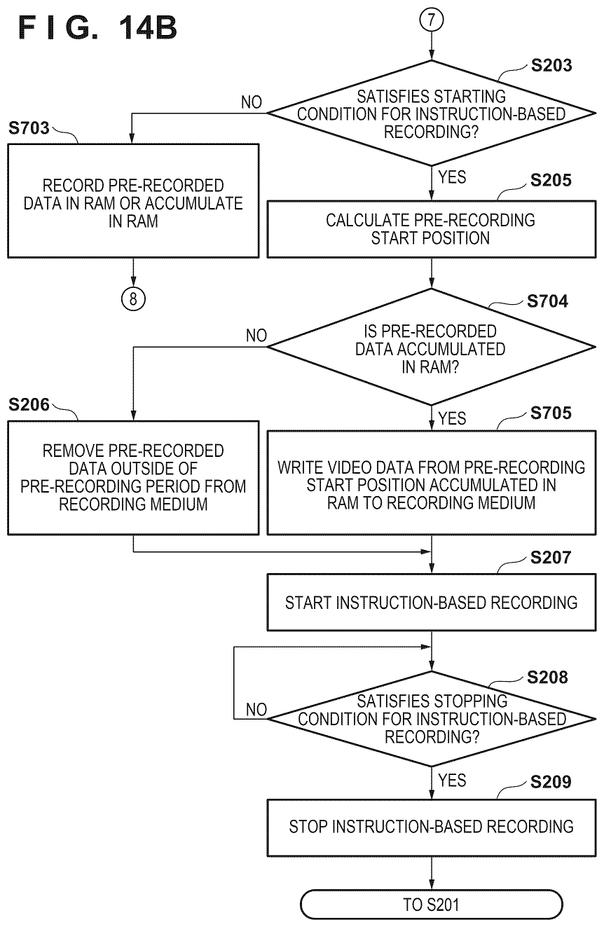

The data recording control operation during pre-recording and instructed recording according the present embodiment will be described in further detail with reference to the flowcharts shown in FIGS. 14A and 14B. This operation is executed in a state in which pre-recording is enabled. Furthermore, it is assumed here that the removal of pre-recorded data other than that corresponding to the pre-recording period is executed when instructed recording is started. Furthermore, the same reference numerals as those in FIG. 3 are provided to steps in which the same processing as that in the first embodiment is executed, the same reference numerals as those in FIGS. 13A and 13B are provided to steps in which the same processing as that in the fifth embodiment is executed, and redundant description thereof is omitted.

In the present embodiment, while pre-recording is executed, the determination in step S700 is executed repeatedly by returning processing from step S703 to step S700 as illustrated in FIG. 14A. The processing until step S701 or step S702 is executed is the same as that in the fifth embodiment, and description thereof is thus omitted.

After step S701 or step S702 is executed, the pre-recording processing unit 109 determines whether or not the determined pre-recording method has changed (has been switched) in step S800. This determination can be realized by referring to the results of the two most recent instances of the determination of the pre-recording method held in the RAM 104. The pre-recording processing unit 109 executes step S801 if it is determined that the pre-recording method has been switched, and otherwise executes step S802.

In step S801, the pre-recording processing unit 109 determines whether or not the pre-recording method before the switch (i.e., the presently executed pre-recording method) was the recording to the recording medium 107. The pre-recording processing unit 109 executes step S803 if it is determined that the pre-recording method before the switch was the recording to the recording medium 107, and otherwise executes step S804.

In step S802, the pre-recording processing unit 109 determines whether or not pre-recording is presently being executed, and advances processing to step S203 if it is determined that pre-recording is presently being executed and otherwise starts pre-recording in step S202. The pre-recording started here is in accordance with the pre-recording method most recently determined in step S701 or step S702.

In step S803, the pre-recording processing unit 109 removes pre-recorded data present in the recording medium 107 in order to execute pre-recording according to the method after the switching, and advances processing to step S203. In such a manner, if switching is performed from the method of executing pre-recording to the recording medium 107 to the method of accumulating data of pre-recording in the RAM 104, pre-recording is executed from the beginning once again.

In step S804, in order to execute pre-recording according to the method after the switching, the pre-recording processing unit 109 records data of pre-recording accumulated in the RAM 104 to the recording medium 107, and advances processing to step S203. In such manner, if switching is performed from the method of accumulating data of pre-recording in the RAM 104 to the method of executing pre-recording to the recording medium 107, pre-recording is continued using data of pre-recording that was accumulated in the RAM 104.

According to the present embodiment, in addition to the same effect as that of the fifth embodiment, it becomes possible to execute appropriate pre-recording even if a setting that affects pre-recording is changed during pre-recording.

### Other Embodiments

Recording control operations for pre-recording and instructed recording in the moving-image mode have been mainly described in the above-described embodiments; however, similar recording control operations can be executed in the still-image mode as well. In the still-image mode, instructed recording may be a single instance of the capturing of a still image, or otherwise, as instructed recording, still images may be captured continuously while the full-press state of the release switch is maintained. In the case of the still-image mode, a plurality of data files generated by pre-recording and instructed recording are stored in association with one another.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. An image recording apparatus that has a pre-recording function for, prior to start of instructed recording, starting recording of an image captured using an image sensor, the image recording apparatus including one or more processors that execute a program stored in a memory and thereby function as units comprising:
a pre-recording processing unit configured to perform the pre-recording; and
an instructed-recording processing unit configured to start the instructed recording of the image captured using the image sensor according to a determination that an instructed-recording starting condition is satisfied while the pre-recording is performed,
wherein the pre-recording processing unit performs the pre-recording onto a non-volatile recording medium that is used for the instructed recording.

2. The image recording apparatus according to claim 1,
wherein the pre-recording processing unit removes, from the recording medium, data recorded by performing the pre-recording, except for data corresponding to a predetermined period that is set as a pre-recording period immediately preceding the start of the instructed recording.

3. The image recording apparatus according to claim 1, further comprising
a volatile memory for temporarily storing data to be recorded to the recording medium,
wherein, the pre-recording processing unit sequentially records data stored in the volatile memory to the recording medium to ensure that a capacity of the volatile memory used in the pre-recording does not exceed a predetermined capacity.

4. The image recording apparatus according to claim 1,
wherein the pre-recording processing unit:
while performing the pre-recording, in a case where a data amount stored in a file reaches a predetermined first threshold, splits the file into a plurality of files that store a data amount corresponding to the first threshold in a distributed manner; and
continues the pre-recording onto a new file.

5. The image recording apparatus according to claim 4,
wherein, while performing the pre-recording, in a case where a total amount of data recorded in the recording medium reaches a predetermined second threshold that is greater than the first threshold, the pre-recording processing unit removes, from the recording medium, a file storing oldest data.

6. The image recording apparatus according to claim 1,
wherein, in a case where a plurality of recording media can be used for the instructed recording, while preforming the pre-recording, the pre-recording processing unit records data to a pre-recording area set in each of the plurality of recording media without recording data to other areas of the plurality of recording media.

7. The image recording apparatus according to claim 6,
wherein, while performing the pre-recording, the pre-recording processing unit records data to the plurality of recording media such that data corresponding to a predetermined period, set as a pre-recording period, immediately preceding the start of the instructed recording is present in one of the plurality of recording media.

8. The image recording apparatus according to claim 6,
wherein, while performing the pre-recording, the pre-recording processing unit:
(a) records data to the pre-recording area of a first recording medium among the plurality of recording media;
(b) in a case where a free space in the pre-recording area of the first recording medium corresponds to a capacity corresponding to a period having a predetermined duration, records data in parallel to both the first recording medium and a second recording medium among the plurality of recording media;
(c) in a case where the free space in the pre-recording area of the first recording medium is exhausted, stops recording data to the first recording medium;
(d) removes data recorded in the pre-recording area of the first recording medium;
(e) in a case where a free space in the pre-recording area of the second recording medium corresponds to the capacity corresponding to the period having the predetermined duration, records data in parallel to both the first recording medium and the second recording medium;
(f) in a case where the free space in the pre-recording area of the second recording medium is exhausted, stops recording data to the second recording medium; and
(g) removes data recorded in the pre-recording area of the second recording medium, and
thereafter repeatedly executes operations (b) to (g).

9. The image recording apparatus according to claim 6,
wherein the pre-recording processing unit removes, from the plurality of recording media, data recorded in the pre-recording except for data corresponding to a predetermined period, set as a pre-recording period, immediately preceding the start of the instructed recording.

10. The image recording apparatus according to claim 6,
wherein one of the plurality of recording media is determined in advance as the recording medium used for the instructed recording, and
in a case where data corresponding to a predetermined period, set as a pre-recoding period, immediately preceding the start of the instructed recording, among data recorded in the pre-recording, is present in a different recording medium from the one of the plurality of recording media, the instructed-recording processing unit:
performs the instructed recording while avoiding the pre-recording area among areas of the one of the plurality of recording media; and
copies the data corresponding to the pre-recording period from the different recording medium to the pre-recording area of the one of the plurality of recording media.

11. The image recording apparatus according to claim 10,
wherein, in a case where the data corresponding to the pre-recording period is present in the one of the plurality of recording media, the instructed-recording processing unit records data of the instructed recording following the data corresponding to the pre-recording period.

12. The image recording apparatus according to claim 1 further comprising
the image sensor,
wherein while performing the pre-recording, the pre-recording processing unit records moving-image data captured using the image sensor, and
the instructed-recording processing unit records, to the recording medium, moving-image data captured using the image sensor during a period between instructions to start and stop the instructed recording.

13. An image recording method to be executed by an image recording apparatus that has a pre-recording function for, prior to start of instructed recording, starting recording of an image captured using an image sensor, the image recording method comprising:
performing the pre-recording; and
starting the instructed recording of the image captured using the image sensor according to a determination that an instructed-recording starting condition is satisfied while the pre-recording is performed,
wherein the pre-recording is performed onto a non-volatile recording medium that is used for the instructed recording.

14. A non-transitory computer-readable medium that stores a program for causing a computer of an image recording apparatus that has a pre-recording function for, prior to start of instructed recording, starting recording of an image captured using an image sensor, to execute an image recording method comprising:
performing the pre-recording; and
starting the instructed recording of the image captured using the image sensor according to a determination that an instructed-recording starting condition is satisfied while the pre-recording is performed,
wherein the pre-recording is performed onto a non-volatile recording medium that is used for the instructed recording.

15. An image recording apparatus that has a pre-recording function for, prior to start of instructed recording, starting recording of an image captured using an image sensor, the image recording apparatus including one or more processors that execute a program stored in a memory and thereby function as units comprising:
a determination unit configured to determine a method for the pre-recording;
a pre-recording processing unit configured to, according to the method determined by the determination unit, start the pre-recording of the image captured using the image sensor; and
an instructed-recording processing unit configured to start the instructed recording of the image captured using the image sensor according to a determination that an instructed-recording starting condition is satisfied while the pre-recording is performed,
wherein, while the pre-recoding is performed, in a case where the method determined by the determination unit is changed, the pre-recording processing unit performs the pre-recording according to the method after the change.

16. The image recording apparatus according to claim 15,
wherein the determination unit determines the method based on one or more of: a free space in a non-volatile recording medium that is used for the instructed recording and a setting of a duration of a pre-recording period.

17. The image recording apparatus according to claim 16,
wherein, in a case where the free space in the non-volatile recording medium used for the instructed recording is no more than a predetermined capacity threshold, the determination unit determines a first method in which data is not recorded to the non-volatile recording medium in the pre-recording.

18. The image recording apparatus according to claim 16,
wherein, in a case where the duration of the pre-recording period is no longer than a predetermined time threshold, the determination unit determines a first method in which data is not recorded to the non-volatile recording medium in the pre-recording.

19. The image recording apparatus according to claim 16 further comprising
a memory for temporarily storing data,
wherein the method for the pre-recording is one of methods including: a first method in which data of the pre-recording is accumulated in the memory while the pre-recording is performed and the data of the pre-recording accumulated in the memory is recorded to the recording medium after the start of the instructed recording; and a second method in which data of the pre-recording is recorded to the recording medium while the pre-recording is performed, and
the determination unit determines the first method in a case where the duration of the pre-recording period is no longer than a maximum duration of pre-recorded data that can be temporarily stored in the memory, and determines the second method in a case where the duration of the pre-recording period is longer than the maximum duration of pre-recorded data that can be temporarily stored in the memory.

20. The image recording apparatus according to claim 17,
wherein the first method is a method in which, while the pre-recording is performed, the data of the pre-recording is accumulated in a volatile memory included in the image recording apparatus.

21. The image recording apparatus according to claim 17,
wherein, in a case where the free space in the non-volatile recording medium used for the instructed recording is more than the predetermined capacity threshold, and the duration of the pre-recording period is longer than a predetermined time threshold, the determination unit determines a second method that is different from the first method.

22. The image recording apparatus according to claim 21,
wherein the second method is a method in which, while the pre-recording is performed, the data of the pre-recording is recorded to the recording medium.

23. The image recording apparatus according to claim 15,
wherein, as the method, the determination unit determines a first method or a second method that is different from the first method,
the first method is a method in which, while the pre-recording is performed, the data of the pre-recording is accumulated in a volatile memory included in the image recording apparatus,
the second method is a method in which, while the pre-recording is performed, the data of the pre-recording is recorded to a non-volatile recording medium that is used for the instructed recording, and
while performing the pre-recording, the pre-recording processing unit:
in a case where the method determined by the determination unit switches from the first method to the second method, performs the pre-recording according to the second method after recording the data accumulated in the volatile memory to the recording medium; and
in a case where the method determined by the determination unit switches from the second method to the first method, performs the pre-recording according to the first method after removing the data recorded in the recording medium.

24. The image recording apparatus according to claim 15 further comprising
the image sensor,
wherein, while the pre-recording is performed, the pre-recording processing unit records moving-image data captured using the image sensor.

25. The image recording apparatus according to claim 24,
wherein the instructed-recording processing unit records, to a non-volatile recording medium that is used for the instructed recording, moving-image data captured using the image sensor during a period between instructions to start and end the instructed recording.

26. An image recording method to be executed by an image recording apparatus that has a pre-recording function for, prior to start of instructed recording, starting recording of an image captured using an image sensor, the image recording method comprising:
determining a method for the pre-recording;
according to the determined method, starting the pre-recording of the image captured using the image sensor;
starting the instructed recording of the image captured using the image sensor according to a determination that an instructed-recording starting condition is satisfied while the pre-recording is performed; and
while the pre-recording is performed, in a case where the method determined by the determining is changed, performing the pre-recording according to the method after the change.

27. A non-transitory computer-readable medium that stores a program for causing a computer of an image recording apparatus that has a pre-recording function for, prior to start of instructed recording, starting recording of an image captured using an image sensor, the image recording method comprising:
determining a method for the pre-recording;
according to the determined method, starting the pre-recording of the image captured using the image sensor;
starting the instructed recording of the image captured using the image sensor according to a determination that an instructed-recording starting condition is satisfied while the pre-recording is performed; and
while the pre-recording is performed, in a case where the method determined by the determining is changed, performing the pre-recording according to the method after the change.
